(19) United States
(12) Patent Application Publication
(10) Pub. No.: US 2013/0001161 A1
(43) Pub. Date: Jan. 3, 2013

(54) Biological Treatment and Compressed Media Filter Apparatus and Method

(76) Inventor: Mark Boner, Roswell, GA (US)

(21) Appl. No.: 13/534,822

(22) Filed: Jun. 27, 2012

Related U.S. Application Data
(60) Provisional application No. 61/502,112, filed on Jun. 28, 2011.
(60) Provisional application No. 61/565,059, filed on Nov. 30, 2011.

(51) Int. Cl. C02F 9/14

(52) U.S. Cl. 210/615; 210/151; 210/97

(57) ABSTRACT

A filter media supporting the biological treatment and filtering of fluids and the method thereof.

### CROSS-REFERENCE TO RELATED APPLICATIONS

This application claims the benefit of priority of U.S. Application No. 61/502,112 filed Jun. 28, 2011 and U.S. Application No. 61/565,059 filed Nov. 30, 2011, both of which are incorporated herein by reference.

### BACKGROUND OF THE INVENTION

The present invention relates to the filtering of particulates from fluids, particularly the removal of solids from water, using compressible filter media in a compressible housing. The present invention also relates to the biological treatment of fluids.

### SUMMARY OF THE INVENTION

A filtering apparatus is described herein that utilizes a compressible filter media within a filter media housing to support a fixed film biological growth for the degradation, adsorption, and/or absorption of soluble organics and/or other micro-constituents from incoming wastewater. The compressible filter media is partially or wholly compressed in the filter media housing, such that particulate material is segregated and separated from the liquid that passes through the compressible filter media. The filtering apparatus can also be operated such that the compressible filter media retains a biological growth to biochemically treat soluble organics. The filtering apparatus using compressible filter media can accomplish biological treatment for a number of wastewater applications.

In one embodiment of the present invention, the filtering apparatus is essentially a compressible filter media with a high rate biological growth that eliminates the requirement for pretreatment like fine screening and/or upstream clarification. The compressible filter media removes soluble and particulate organic constituents through both biological treatment and entrapment by filtration within the compressible filter media, producing an effluent that does not require downstream clarification. The filtering apparatus may qualify as secondary treatment. The filtering apparatus can be used as a pretreatment step, as a stand-alone secondary treatment process, as an effluent polishing process, and/or as wet weather treatment technology where regulations may require biological treatment.

In one embodiment the filter media housing is a flexible housing material. In other embodiments, the filter media housing may include hinged container walls, sliding mechanisms or similar movable housings for inwardly compressing filter media within the housing.

In an embodiment of the invention, a flexible housing contains the compressible filter media within an open inner fluid retaining space of a filter apparatus. As the hydrostatic pressure of unfiltered fluid surrounding the housing exceeds the pressure within the housing, the housing and media therein are compressed. Different compression zones and corresponding particle size capture levels are achieved with different initial inner fluid volumes or porosity.

In another embodiment of the invention, the outer surrounding fluid to be filtered is used to compress the filter media within the filter media housing. In another embodiment of the present invention, the compressible media is compressed by means of mechanically movable plates or similar components.

In another embodiment of the present invention, a compressible filter media of multi-component fibers is used inside the flexible housing of the filter media. The specific gravity, fiber filament diameter, resilience, chemical resistance, stiffness, media bundle size and filtering performance of the compressible media can be adjusted to the fluid being filtered and to the filtering needs by using single and multi-component fibers.

In one embodiment, the compressible filter media comprises small denier filament diameters that provide significantly greater surface area for bio-film growth and for binding the bio-film within the interstices of the fiber media bundle.

In one embodiment, the compressible filter media comprises fibers with a nylon inner core and polypropylene sheath. In such an embodiment, the fibrous bundles have low resilience and lower specific gravity.

In another embodiment, the compressible filter media comprises fibers with a polyester inner core and polypropylene sheath. In such an embodiment, the fibrous bundles are heavier and more resilient.

In another embodiment, the fluid to be filtered drops into the filter media housing in such a manner so that the fluid to be filtered is aerated prior to entry into the filter media housing and as the fluid flows through the filter media.

In another embodiment, the fluid to be filtered is introduced into the filter media in such a manner that the fluid carries air under pressure into the filter media, and the air assists in the aeration of the biological growth within the media bundles.

In another embodiment, a portion of the flexible housing and the contained media are allowed to relax during the filtration cycle enabling further penetration of solids by fissuring through the media bed.

In another embodiment of the present invention, the filter apparatus may be used in conjunction with a backwash thickening and clarification process that recycles supernatant containing intrinsic microbiology back to the filtration process and reduces the backwash solid volume for further processing.

In one embodiment, the resilience and stiffness of the fiber filament used in the media bundles can enhance the removal of the excess biological growth and captured particles as well as increase fluid penetration during filtration.

In one embodiment, the size of the media bundle used can optimize the containment of the bio-film in the interstices of the bundle, the removal of excess biological growth and captured particulates, and the fluid penetration during the filtration mode.

In still other embodiments, a plurality of filter apparatuses may be used to create a matrix of filters to treat large amounts of fluid, such as in a basin or other large structure or containment. In such embodiments, multiple filter apparatuses can form a single cell, and multiple cells can be configured to treat a portion of the cell matrix while backwashing in a different portion of the cell matrix.

In still other embodiments, a multistage bio-filtration matrix can be configured wherein the fluid to be processed flows through each stage and receives biological treatment specific to that stage. Each stage of treatment may contain different biology populations specific to the constituent being removed or converted. Each stage of treatment may utilize different backwashing gases and/or fluid only, backwash thickening, and recycling.

### BRIEF DESCRIPTION OF THE DRAWINGS

FIG. 1A is a schematic cross-sectional view of a single filter apparatus of the present invention showing a flexible housing for containing filter media in an embodiment of the present invention.

FIG. 1B is schematic cross-sectional view of a single filter apparatus.

FIG. 1C is schematic cross-sectional view of a single filter apparatus for the entrainment of air under pressure.

FIG. 1D is schematic cross-sectional view of a single filter apparatus wherein an upper portion of the flexible housing can relax while a lower portion of the flexible housing remains compressed.

FIG. 1E is a schematic cross-sectional view of a single filter apparatus wherein an upper portion of the flexible housing can relax while a lower portion of the flexible housing remains compressed.

FIG. 2A is a schematic cross-sectional view of the filter apparatus of FIG. 1A during initial filling with fluid to be filtered.

FIG. 2B is a schematic cross-sectional view of the filter apparatus of FIG. 1B during initial filling with fluid to be filtered.

FIG. 3A is a schematic cross-sectional view of the filter apparatus of FIG. 1A as the hydraulic head becomes greater upstream than in the downstream flow and the hydrostatic pressure of the unfiltered fluid compresses the flexible housing.

FIG. 3B is a schematic cross-sectional view of the filter apparatus of FIG. 1B as the hydraulic head becomes greater upstream than in the downstream flow and the hydrostatic pressure of the unfiltered fluid compresses the flexible housing.

FIG. 4A is a schematic cross-sectional view of the filter apparatus of FIG. 1A as influent level reaches an optional overflow pipe.

FIG. 4B is a schematic cross-sectional view of the filter apparatus of FIG. 1B as influent level reaches a maximum level before the relaxation of a portion of the flexible housing.

FIG. 5A is a schematic cross-sectional view of the filter apparatus of FIG. 1A during backwash operation in an embodiment of the invention.

FIG. 5B is a schematic cross-sectional view of the filter apparatus of FIG. 1B during backwash operation in an embodiment of the invention.

FIG. 5C is a schematic cross-sectional view of the filter apparatus of FIG. 1B during a wastewater introduction operation in an embodiment of the invention.

FIG. 5D is a schematic cross-sectional view of the filter apparatus of FIG. 1B during a de-nitrification operation in an embodiment of the invention.

FIG. 6 is a front perspective view of a filter media bundle in an embodiment of the present invention.

FIG. 7 is a cross-sectional view of a filter media element including a hog ring/binding wire crimping and holding the center of the filter media bundle fibers in an embodiment of the invention.

FIG. 8 is a schematic cross-sectional view of a concentric bi-component fiber in an embodiment of the invention.

FIG. 9 is a schematic cross-sectional view of an eccentric bi-component fiber in an embodiment of the invention.

FIG. 10 is a schematic cross-sectional view a multi-component fiber in an embodiment of the invention.

FIG. 11 is a schematic cross-sectional view depicting first and second compression zones of compressible filter media in a filter media housing in an embodiment of the invention.

FIG. 12A is a schematic top plan view of a plurality of filter units within a large fluid containment in an embodiment of the invention.

FIG. 12B is a schematic cross-sectional view of a plurality of filter units along line II-II of FIG. 1.

FIG. 13 is a top plan view of a multiple cell filter matrix each with a plurality of filter apparatuses.

FIG. 14 is an enlarged sectional view of a portion of FIG. 13.

FIG. 15 is a schematic cross-section view of the cell filter of FIG. 13 along line A.

FIG. 16 is a schematic cross-sectional view of FIG. 13 along line B.

FIG. 17 is a front perspective view of a filter media bundle hosting biological growth according to an embodiment of the invention.

FIG. 18A is a diagram of a filter apparatus according to one embodiment of the present invention.

FIG. 18B is a diagram of the filter apparatus of FIG. 16A illustrating a backwash process.

FIG. 19A is a diagram of a filter apparatus according to one embodiment of the present invention.

FIG. 19B is a diagram of the filter apparatus of FIG. 17A illustrating a backwash process.

FIG. 20 is a flow diagram of a single stage bio-filtering and treatment process according to an embodiment of the present invention.

FIG. 21 is a flow diagram of a multi-stage bio-filtering and treatment process according to an embodiment of the present invention.

FIG. 22 is a graph of test results of a treatment process utilizing an embodiment of the present invention.

### DETAILED DESCRIPTION OF THE INVENTION

An apparatus and method for filtering and treating fluids with compressible filter media containing a biological growth is described herein. In the described embodiments, the filter media is compressed through various means, including, but not limited to, fluid outside a flexible housing retaining the filter media. A variety of external forces, including those applied by mechanical plates, may be applied to the compressible media to achieve the objectives of the invention in other embodiments. Although the invention is described in embodiments for top down filtering of fluid, the apparatuses and components described herein may be positioned such that the filtration may occur in other directions, and repositioning is within the scope of the invention. Further, in additional described embodiments, the fluid is filtered and treated through various ways, including, but not limited to aerobic and anaerobic processes.

The apparatus thus produces improved filtration and fluid treatment, and is particularly adapted for the filtration and treatment of stormwater, drinking water, and wastewater. The apparatus may be used in filtration and backwash applications, similar to those disclosed in U.S. Pat. No. 7,223,347, issued May 29, 2007, and U.S. Pat. No. 7,435,351, issued Oct. 14, 2008, both fully incorporated by reference. Further, embodiments of the present invention can be utilized in pretreatment steps, as a standalone secondary treatment process, as an effluent polishing process, and/or as a wet weather treatment process where regulations may require biological treatment. In other embodiments the apparatus can be used with a variety of fluids, treatments, and filtering applications.

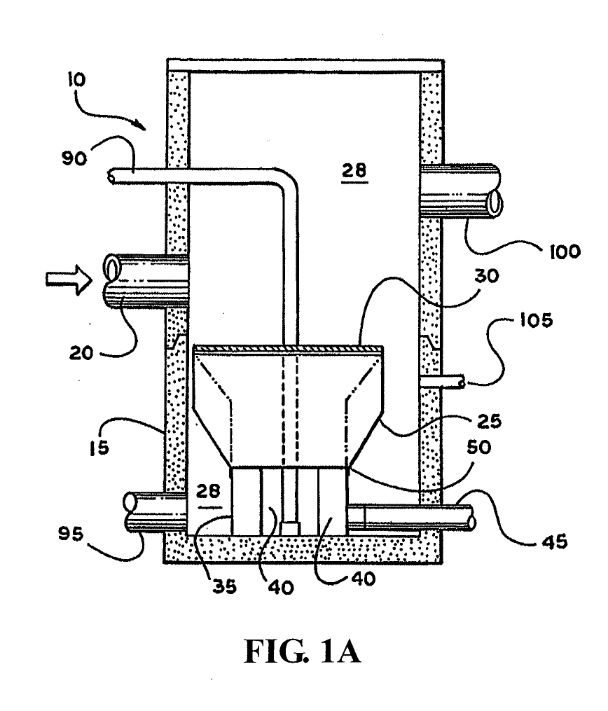

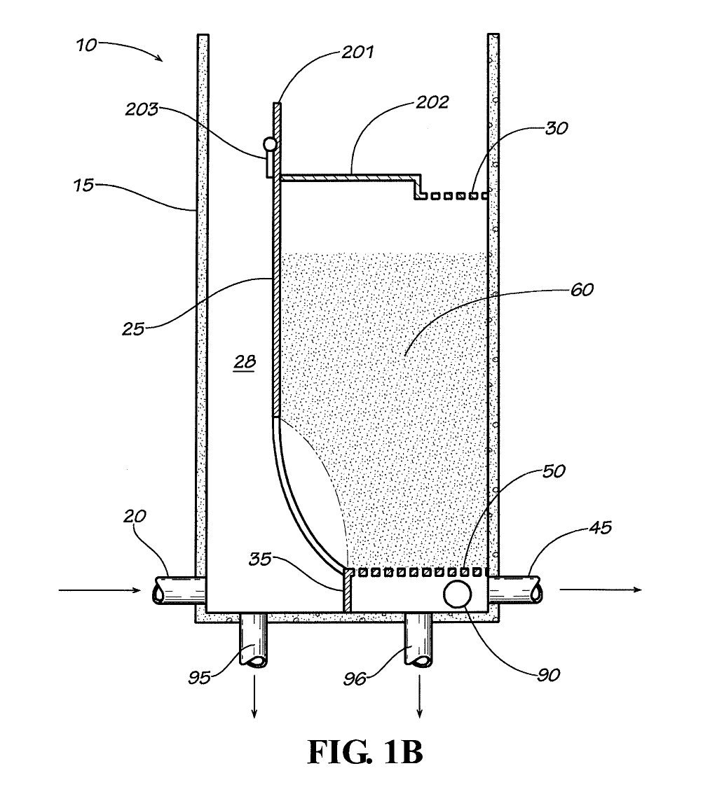

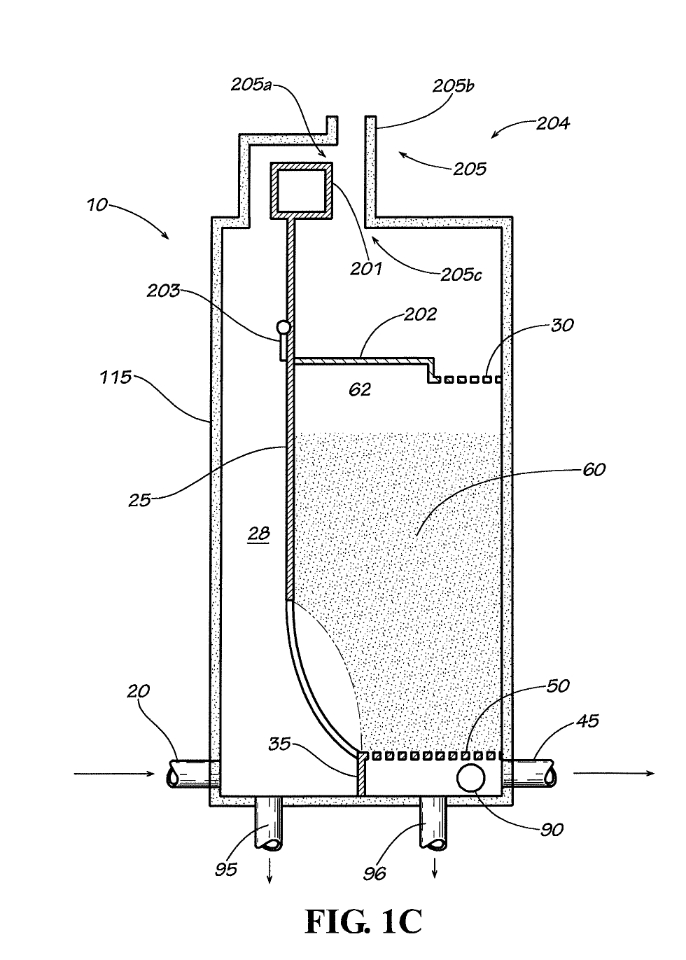

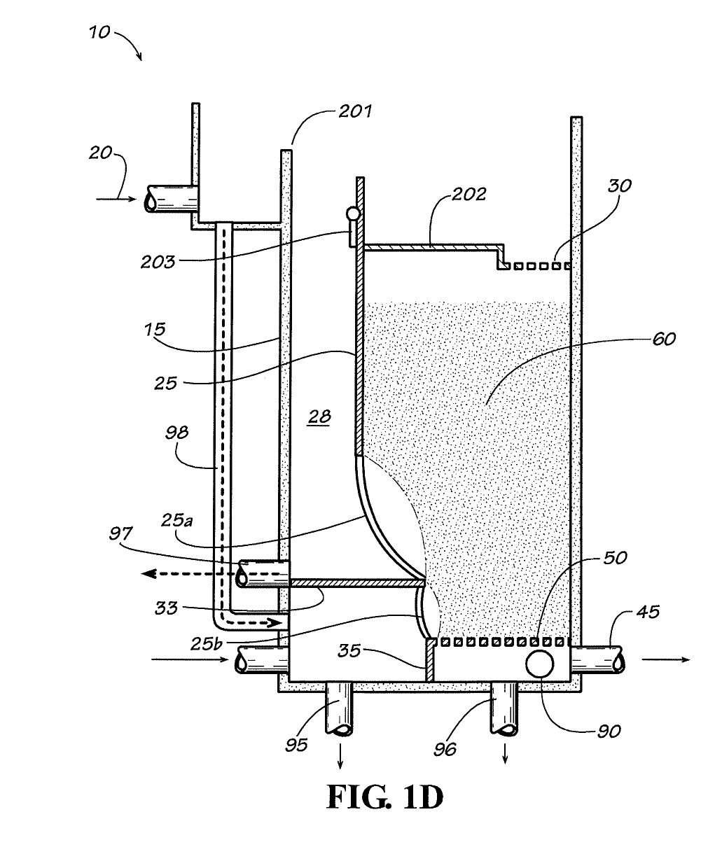

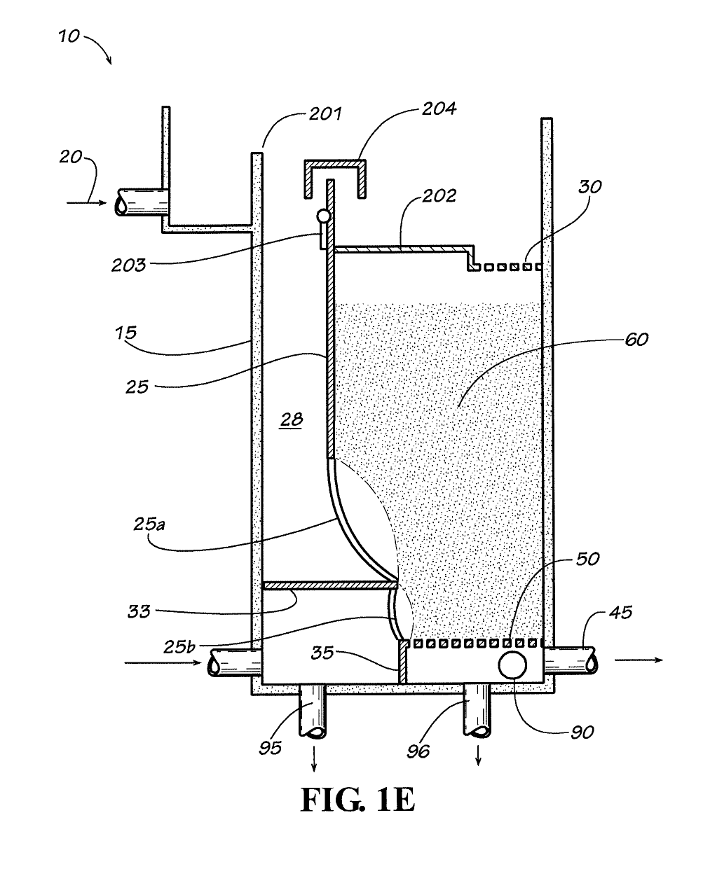

Referring to FIG. 1A, which illustrates an embodiment of the present invention, a filter apparatus 10 includes an outer containment structure 15. Outer containment structures 15 include concrete containers, earthen basins, natural water features (including a lake), and like environments in which fluid to be filtered may be contained. An influent pipe 20 conducts fluid to be filtered into the containment structure 15. The influent pipe 20 may be located in a variety of positions (such as above or below the top of the filter) and or/include a plurality of influent pipes 20 (or weirs).

An upright filter media housing 25 is positioned within the outer containment structure 15. FIG. 1A depicts the filter media housing 25 comprising a flexible membrane in both expanded and compressed configurations to demonstrate compressibility of the housing 25. The top of the filter media housing 25 includes an upper perforated plate 30 for retaining the filter media within housing 25. The perforated plate 30, like a fine screen, pre-screenings the fluid flowing into the housing 25 for treatment. The perforated plate 30 also allows backwash fluid to flow out of the housing 25. A housing base 35 supports the filter media housing 25 at the bottom of the outer containment structure 15.

In other embodiments, such as those shown in FIG. 1B, the top of the media housing 25 may include a weir 201 that distributes fluid to be filtered into the media housing 25. The weir 201 can also distribute fluid to be filtered between multiple filter apparatuses 10 used in conjunction with another embodiment discussed below in more detail. A backwash trough 202 with an outlet flap 203 and an upper perforated plate 30 are positioned below the top of the weir 201.

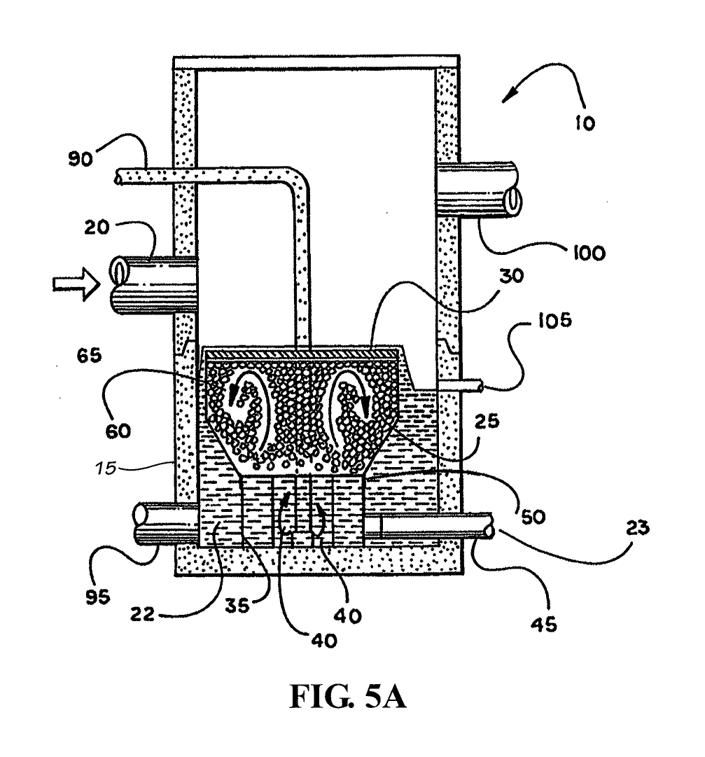

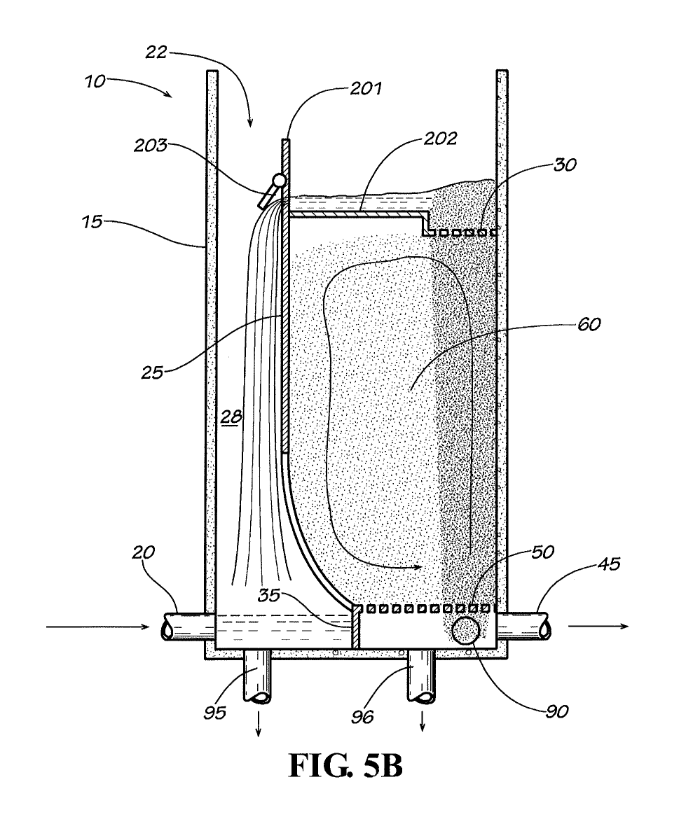

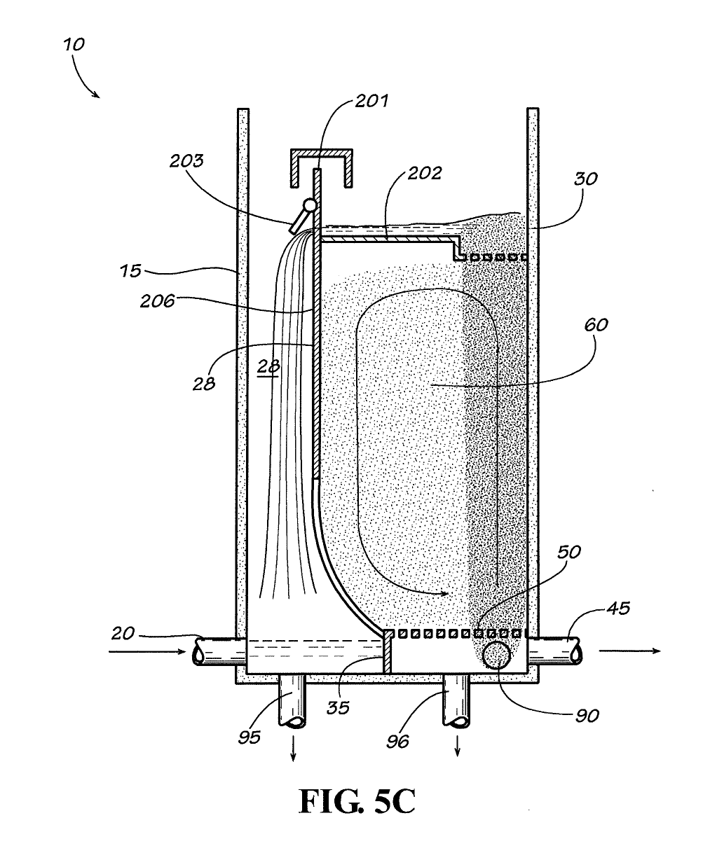

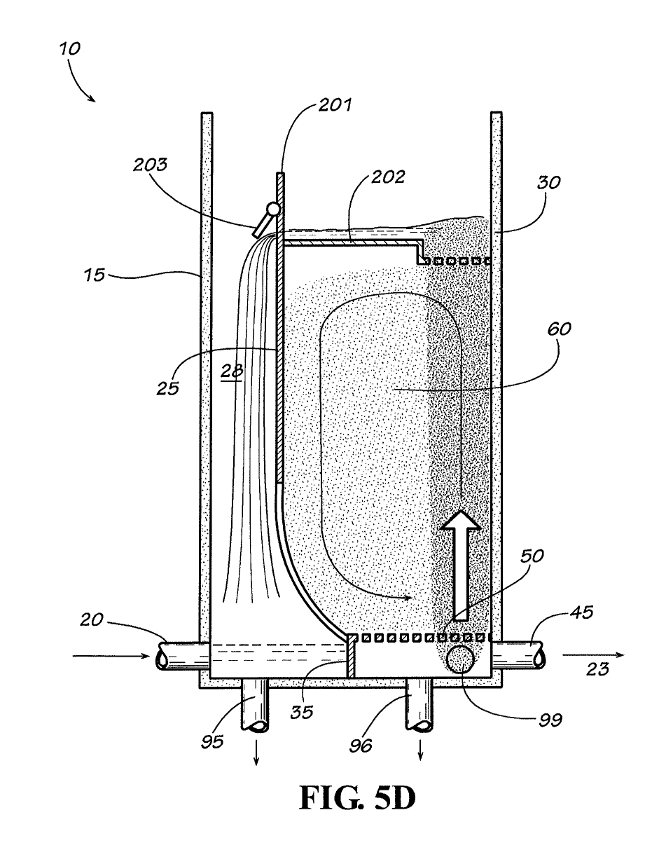

In one embodiment, FIG. 1A, the base 35 may include baffles 40 that direct filtered and treated fluid to an effluent pipe 45 carrying the filtered fluid from the filter housing 25 and out of the outer containment structure 15. The effluent pipe 45 carries away the filtered and treated fluid. The baffles 40 may also direct air for aeration and make-up water to the center or side of lower perforated plate 50 during backwashing operations (FIGS. 5A and B), which is discussed in more detail below. While embodiments of the present invention may refer to pipes carrying influent to and effluent from the filter apparatus 10, canals, conduits, and/or channels, or their equivalents, may be used to transfer fluids to and from the filter apparatus. In addition, various fluid controlling mechanisms, including, but not limited to, valves, gates, and other fluid controlling mechanisms may be used to direct, allow, and cut off fluid passage into or out of the filter apparatus 10.

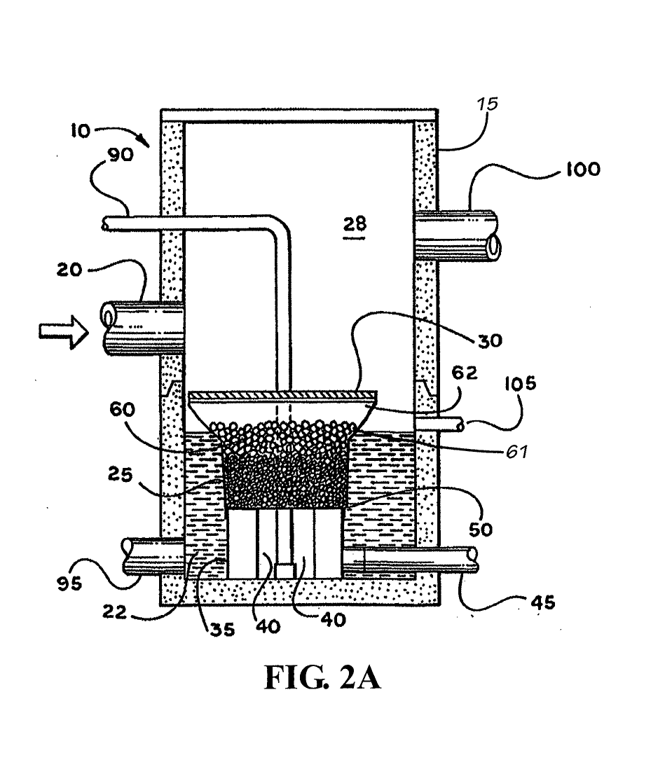

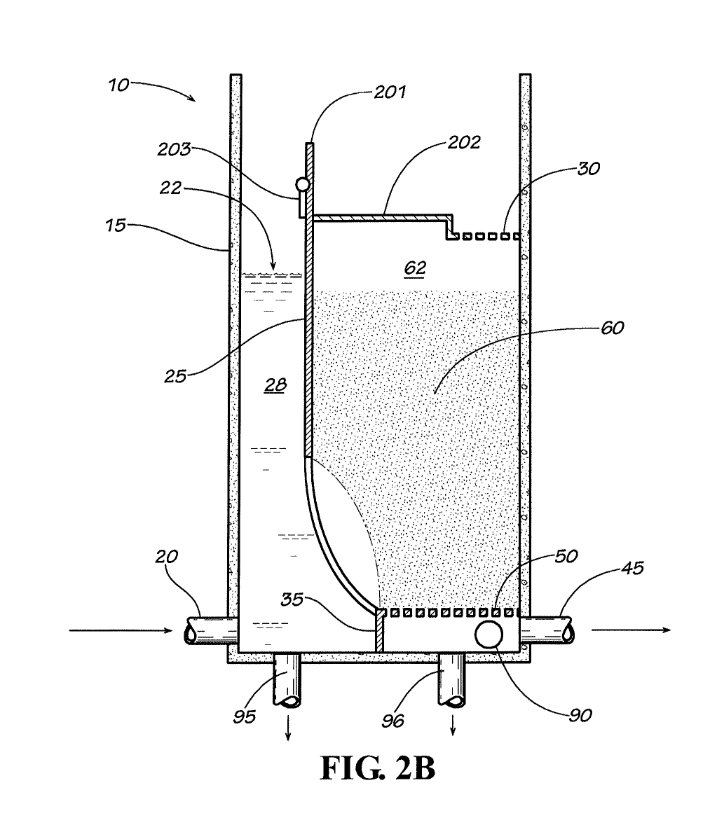

Referring again to FIGS. 1A and 1B, the lower perforated plate 50, located between the upper plate 30 and base 35, allows filtered and treated fluid to exit the flexible housing 25. The lower perforated plate 50 also supports and retains filter media 60 (FIGS. 2A and 2B) within the housing 25.

With reference to FIGS. 2A, 2B, and 6-10, a compressible filter media 60 is contained within the housing 25 between the upper perforated plate 30 and lower perforated plate 50. In certain embodiments of the present invention, the filter media 60 is composed of multiple media bundles 61 composed of fiber filaments 63 with physical characteristics that: 1) support biological growth 80 for the removal of soluble constituents, 2) provide a porosity gradient for stratified separation of large and small particles, and 3) are readily fluidized for efficient air/water cleaning during backwash. A porosity gradient is achieved through the media bed within a two or three dimensional conical shape of the flexible housing. With respect to the porosity gradient, the media bundles 61, when appropriately compressed, produce a stratified separation of large and small particles from the liquid being filtered. Filtration pathways, within an upper zone of the media bed 60 and along the outer portions of the media bundles 61 contained therein, are established during the filtration mode for, filtering out larger particles and allowing smaller particles to flow towards the center of the media bundles 61 as well as toward the center and lower portions of the media bed 60. As the upper zone of the media bed 60 collects particles, the media bundles 61 along the outer zone begin to compress and separate from the adjacent media bundles 61 closer to the center of the media bed 60. Individual media bundle compression results in fissuring, where the fluid to be filtered and the solids carried by the fluid penetrate deeper in the media bed 60 through opened passageways. Fissuring continues until the pressure from the solids on the individual media bundles 61 cannot separate and overcome the compression of the media bed 60 by the flexible housing 25.

With respect to backwash cleaning, the media bundles 61 are sufficiently flexible so that when backwashed with an appropriate fluidized mixture of air and water, the outer fibers 63 will release the captured particles and excess biological growth 80. Further, during backwashing, the center interstices (the space between the fibers 63 around the center of the media bundles 61) will maintain an appropriate volume of bio-film for the subsequent filtration and biological treatment cycle.

In some embodiments, the media bundles 61 are made of low denier filament fibers 63. The lower the denier, the greater the surface area created by the fibers 63 to which the biological growth can attach. For example, one embodiment of the present invention includes filament fibers 63 of approximately 11μ to 13μ (micron) in diameter with approximately 15,000 filaments 63 per media bundle 61 having a Specific Surface Area (SSA) of approximately 1,200 to 1,500 square meters of filament surface area per cubic meter of filter media (m²/m³). The high unit surface area allows for greater biological growth 80 to develop. The greater the amount of biological growth 80, the shorter the retention times across the media bed for soluble organic uptake during the filtration process.

This SSA is approximately 30 times that of a standard rock media trickling filter or about 10 to 20 times those of the high-rate plastic media trickling filter technologies. The SSA of this embodiment is approximately equal to that of a packed bed submerged attached growth bioreactor or about half that of a fluidized bed bioreactor. The high SSA encourages greater biological growth 80 to develop and therefore results in shorter retention times across the media bed 60 for soluble organic uptake by the biological growth 80. Even with a high SSA, the porosity of the media bed 60 is 80% to 90%, which allows higher hydraulic loading rates (HLR). Compared to other submerged attached growth bioreactors, such as packed bed technologies, the media bed 60 of the present embodiment has a peak HLR that is approximately 6 times greater and is a much more efficient filtration process. Further, while the present embodiment has a peak HLR that is approximately equal to that of fluidized bed technologies, the present embodiment of the invention has filtration capability as well as biological treatment in one step, whereas the fluidized bed technologies require a separate filtration step.

In one embodiment, the filter media 60 is composed of media bundles 61 containing multi-component fibers 63 where two or more synthetic materials are used in the same fiber to achieve desired physical characteristics such as specific gravity, resilience, chemical resistance, curliness, flexibility, stiffness, filament diameter and the like. Bundles of multi-component fibers of small filament diameters create a very large surface area that supports and retains attached microbial bio-film. The multi-component fiber has an inner core for strength and an outer core for chemical resistance needed for the intended filtration applications.

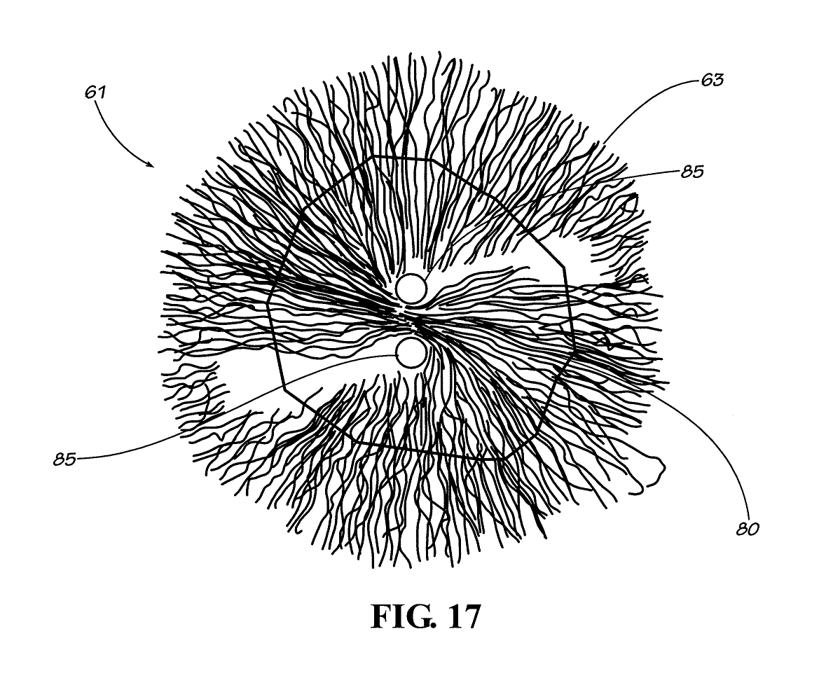

The bundles 61 of curly filaments possess a good combination of stiffness and resilience. The curly filaments assist in the media bundles 61 clinging together and, when appropriately compressed by the flexible housing 25, produce a porosity gradient from large to small pores as the fluid passes through the filter media 60. The porosity gradient of the filter media bed 60 will generally stratify solids by size allowing solids, such as particulates and organic materials, to penetrate deeper into the media bed before cleaning is required. The individual bundle 61 is flexible enough such that when particles/particulates coat the outer layer of an exposed bundle 61, the coating causes further compression by the fluid moving across the coating resulting in additional passageways for fluid to flow deeper into the filter media 60. This fissuring action will continue until the compression of the filter media 60 by the accumulated particulates on the surface of the bundle 61 cannot further separate or fissure the media bed 60 by overcoming the compression of the filter media 60 caused by the flexible housing 25. The media bundles 61, and their filaments 63, are resilient and flexible such that when backwashed with a fluidized bed of air and fluid, the fibers 63 will stretch out thereby releasing the bulk of captured particulates and excess biological growth 80 and yet retain the remaining biological growth 80 in the middle of the media bundle 61, as shown in FIG. 17.

In other embodiments, the filter media fiber may further include components with specifically desired performance characteristics such as specific pollutant removal capabilities. For example, oleophilic fiber components may be used in embodiments for attracting oil from fluid being filtered or hydrophobic fibers may be used to encourage water filtration. In another embodiment of the invention, extruded fiber filaments 63 with nano-particles can be used to offer specific chemical constituent selection or physical bio-growth attachment capabilities. For example, nano-particles having the ability to selectively attach to wastewater constituents have been embedded in fiber filaments 61.

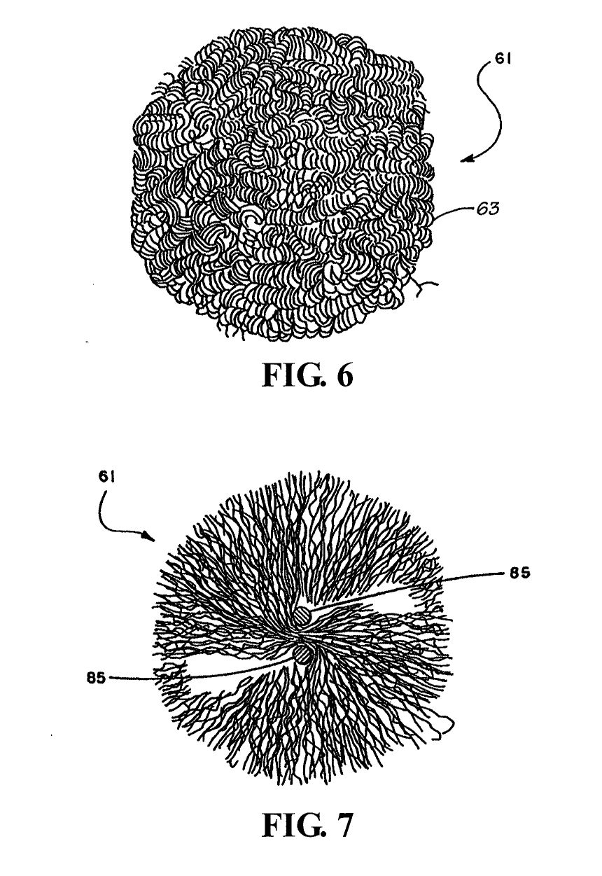

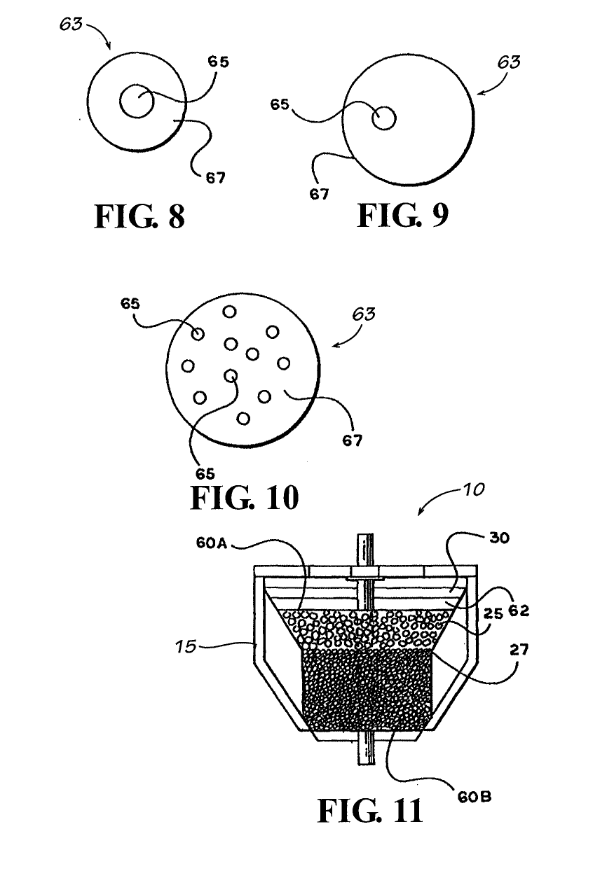

A wide variety of other combinations of components in the filter media may be adapted for use in the apparatus depending on the desired performance, the type of fluid and pollutants being filtered, as well as the types of organics and micro-constituents that require removal from the fluid. In one embodiment to achieve a chemically resistant fibrous bundle 61 of low resilience and lower specific gravity, a fiber 63 is manufactured with a nylon inner core and polypropylene outer cover. In another embodiment in order to obtain a heavier, more resilient bundle 61 (FIGS. 6 and 7), the fiber 63 is manufactured using a polyester inner core with a polypropylene sheath. Referring to FIG. 8, in one embodiment the multi-component fiber is a bi-component fiber, wherein an inner fiber 65 and an outer fiber 67 (sheath) are extruded in a generally concentric configuration. Referring to FIG. 9, in another embodiment the components of the fiber 63 are generally eccentric with the inner component 65 being off-center. In such an embodiment, the eccentric configuration permits heating of the fiber to produce crimping based on the resultant heat distortion.

In alternative embodiments a plurality of fibers 63 may include inner fibers 65 contained in a sheath 67, such as shown in FIG. 10. In such embodiments, the plurality of inner fibers 65 may be the same or different component materials. One or more additional outer sheaths 67 may be provided in alternative embodiments to achieve specific pollutant removal as well as exhibit desired physical characteristics.

In various embodiments, core and sheath materials may include combinations of the following, or other synthetic fibers: polyester (PET), coPET, polylactic acid (PLA), polytrimethylene terephthalate, polycyclohexanediol terephthalate (PCT), polyethylene napthalate (PEN); high density polyethylene (HDPE), linear low density polyethylene (LLDPE), polyethylene (PE), polypropylene (PP), PE/PP copolymer, nylon, polyvinylidene fluoride (PVDF), polytetrafluoroethylene (PTFE), and polyurethane.

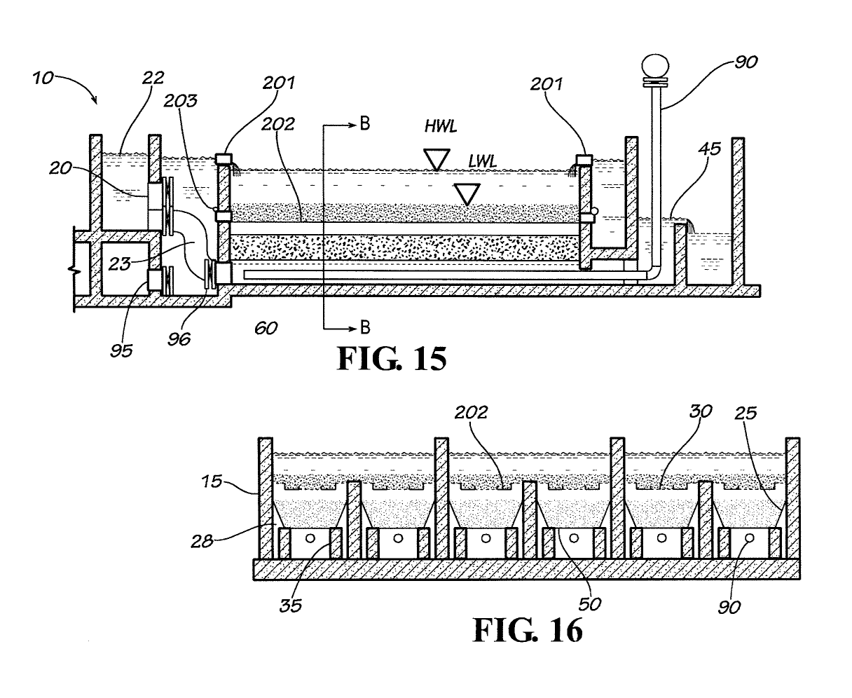

The compressible filter media 60 serves two purposes for the filter apparatus 10: to host biological growth 80 used to treat the influent and to filter particles from the influent. The media bundles 61 of the compressible filter media 60 provide support and a place of attachment for the biological growth 80. The biological growth 80 is a bio-film, defined as assemblages of bacteria cells enclosed in an adhesive matrix excreted by the bacteria cells. The micro-organisms within the biological growth 80 are naturally found in waste water. The bio-film 80 is typically a mixture of polysaccharides and micro-organisms that utilize trapped nutrients for microbial growth 80. The biological growth 80, and more specifically the bacteria cells, attaches to the surfaces of the fibers 63 of the media bundles 61 by the adhesive matrix. The adhesive matrix of the bio-film helps prevent the detachment of cells in flowing systems. The bio-film 80 is primarily attached to and maintained within the center of the media bundle 61, as shown in FIG. 15.

As shown in FIGS. 7 and 17, the fiber filaments 63 of the media bundles 61 are bound together by a clip 85. It is preferable that the clip be comprised from a durable material, such as metal and the like, due to the wear and tear that the bundles 61 experience during the filtration and backwash cycles. The clip 85 bounds the filament fibers 63 together in the center of the media bundle 61, allowing the bio-growth 80 to remain attached in the tight inner intertices and not be scrubbed away during backwash. The clip 85 also gives the bundle 61 weight and strength and makes each bundle a separate structure among many bundles forming the matrix structure of the media bed 60. The uniform matrix structure after cleaning produces the porosity gradient when laterally compressed (which in turn produces the stratified removal of large and small particles by filtration) and uniform flow passageways (which in turn optimizes the uniform contact with the bio-growth 80 in the center of the bundle 61). Further, because the bundles 61 are individual they can be completely mixed during backwash and thus uniformly cleaned.

However, the filament fibers 63 may be held together through various other means. For example, the media bed 60 may comprise an inter-woven or non-woven mass of fibers attached to the side of the flexible housing 25. When attached to the flexible housing the interwoven mass of fibers expands when uncompressed and therefore can be cleaned. This embodiment would also require the fibers to be larger in diameter, thereby creating less surface area for attachment of the biological growth 80 and increasing the possibility of the biological growth from being washed off during the backwash cycle.

The size of the media bundle 61 must be sufficient to both contain an effective volume of biological growth 80 in the center of the media bundle 61 and to allow an outer zone of cleaned fibers 63 after backwashing for water passageways for solids filtration. A media bundle 61 in the range of 1 inch to 3 inches in diameter is the approximate optimal size to promote these attributes. The size of the media bundles 61, however, can vary greatly.

Biological growth 80 in the media bundle 61 can become excessive, leaving less room for fluid passage during filtration. The amount of biological growth 80 can be controlled by adding a low dose of chlorine or other oxidant or antibacterial agent during backwash to reduce the amount of the biological growth 80 along the outer zone of the media bundle 60. Multi-component fine filament kinked fibers 63, when bound together by the metal clip 85 (as shown in FIGS. 7 & 17), form a sufficiently-sized, neutrally buoyant media bundle 61 that possesses sufficient strength, chemical resistance, compressibility, and resilience for the media bed 60 that supports biological growth 80 for soluble organic removal and heavy load solids separation with a filtered effluent suitable to meet several regulatory treatment needs.

By alternating periods of aeration during backwashing followed by periods of filtration, soluble and particulate organics and nutrients are introduced to the biological growth 80, resulting in healthy microbial populations. The biological growth 80 synthesizes the soluble organics and nutrients present in the fluid to be filtered to grow more micro-organisms and produce more bio-film. The biological growth 80 utilizes the air from the backwash cycle and from draining (and the aerated influent when possible), and more specifically the oxygen within, to synthesize the soluble organics (with the oxygen being the electron acceptor for the aerobic bacteria).

Further, the subject filter 10 may be used with anaerobic and facultative bacteria in an anaerobic or an anoxic process. In such instances, the anaerobic bacteria uses nitrates as the electron acceptor for synthesis. In a multiple stage system or in a denitrification system utilizing anoxic or anaerobic environments, air is minimized or eliminated by backwashing with fluid only and not fully draining the media bed 60 and exposing the bio-growth 80 to air.

Excess biological growth 80, including the cells and bio-film, is removed in the backwash process. The outer periphery zone of the media bundle 60 is where the excess bio-growth 80 and filtered particles will be cleaned, whereas the bio-growth 80 located within the center of the media bed 60 will be retained due to the small nature of the interstices at this location. Most of the remaining micro-constituents and particulates, not used by the biological growth 80, become trapped and separated from the fluid by the filter media bed 60 and for the most part are released during the backwash media cleaning process. Other smaller particulates and soluble constituents, not used by the biological growth 80 or not entrapped by the filter media bed 60, will exit the filter 10 in the filtered effluent. Deeper media beds 60 with a greater number of media bundles 61 will remove a greater amount of soluble constituents from the influent fluid to support the biological growth 80.

Multiple stages of bio-filtration with completely mixed bundles 61 can be configured and operated to develop various types of biological communities in order to address specific biological treatment functions. For example, the treatment may include an aerobic, an anaerobic, and an anoxic environment to optimize the removal of carbon, nitrogen, and phosphorous in a biological nutrient treatment process. Filters can be used in a series of treatment processes or stages to accomplish similar removals that occur in multistage activated sludge or submerged bioreactor treatment processes.

As discussed above, and as shown in FIG. 17, the biological growth 80 is supported by a filter media 60 that is made from individual detached bundles 61. Using detached bundles 61 as support for the biological growth 80 offers several advantages over other types of filter media. By using individual detached bundles 61, the surface area to which the biological growth 80 can attach forms an evenly distributed structural matrix of water passageways and bio-film. That matrix optimizes the distribution of fluid and removal of particulates which in turn maximizes contact of soluble constituents with the attached bio-film 80.

Further, individual detached bundles 61 increase the efficiency of the backwash process by improving the removal of trapped particulates and excess biological growth 80 as discussed in more detail below. In addition, the structural matrix of the individual detached bundles 61 containing the biological growth 80 increases the contact between and among the biological growth 80, the organics and nutrients in the fluid being filtered, and the air/oxygenated fluid during the filtration and draining modes. In addition, during backwashing, the detached bundles 61 are uniformly mixed in a fluidized bed of air and water for the maximum contact between the individual media bundles 61, the biological growth 80, and the air/oxygen mix. The media bundle's exposure to air/oxygen efficiently maintains the desired biological growth 80 and extends the filtration cycle. Also, the detached bundles 61 assist the decompression and fluidization of the filter media bed 60 during the backwash process, further facilitating air/oxygen exposure to the media bed 60 and the biological growth 80. In a multi-stage bio-filtration process in which a particular stage is operated in an anoxic or anaerobic condition, air may not be introduced in the same manner or at all. In this mode of operation, the backwashing or cleaning of particles and excess growth may occur with fluid and/or gases other than air. The individual detached bundles 61 will develop a biological growth 80 as they are exposed to the wastewater to be filtered when the wastewater nutrients and air/oxygen (or the lack of it) are available in proper combinations to support biological growth.

Once developed, the biological growth 80 will continue as long as supporting environmental conditions are maintained. The biological growth 80 can go dormant if left in a drained condition. However, the biological growth 80 will return within a short period when food and proper aerobic conditions are returned. Biological treatment conditions are optimized throughout the entire cycle in the three modes including filtration, backwash, and draining, discussed below.

For aerobic bio-filtration, as illustrated in FIGS. 1B-5B, air is introduced in all three modes of a complete cycle. In the filtration mode, the wastewater is introduced at the weir 201, which aerates the wastewater by falling from the maximum influent head level at weir 201, and splashing onto the backwash troughs 202, thereby further dispersing and aerating the fluid through the upper perforated plate 30 and onto the top of the media bed 60, or rising water 22, as shown in FIGS. 2B-4B.

In the backwash mode, as shown in FIG. 5B, air passing through the diffuser 90 is used to fluidize the entire media bed 60, thereby agitating and scrubbing the individual media bundles 61 to loosen the captured particles and excess biological growth 80 from the outer zone of the media bundle 60. The air also lifts the spent backwash, with captured particles and excess biological growth 80, through the upper perforated plated 30, into the backwash trough 202, and through the flap valve 203 on its way to the waste drain 95. Makeup water 23 is introduced to the fluidized media bed 60 at a low rate in order to efficiently clean the media 60 while appropriately aerating the retained biological growth 80.

In the third mode of the entire cycle, the remaining fluid is completely drained from the media bed 60 from the drain line 96. In the drain mode, the media bundles 61 settle with the draining of the remaining fluid and air is sucked into and throughout the media bed 60, further creating an aerobic environment surrounding the retained bio-film 80 by air passageways in the outer fiber zone of the media bundles 61. Air is uniformly entrained through the media bed 60 as the water is drained.

A new filtration cycle begins as the fluid to be filtered rises and compresses the media bed before filtration starts. The length of time in each mode of operation is important to the maintenance of a healthy bio-film for the treatment desired. The greatest aeration for biological growth is accomplished in the backwash and draining periods. The filtration mode has the least oxygen input as the filter 10 reaches its highest headloss due to the reduction of splashing and contact between the air and water as the influent falls from the weir 201 and as the water level inside the containment approaches the weir 201, near the end of the filtration cycle. Headloss is measured as the height of the water level over the filter media 60 within the flexible container minus the effluent water level. As solids are removed from the influent and trapped in the filter, thereby plugging up the pores, more head (height of water on the upstream side) is required to push the flow through the media bed 60 because the downstream level is fixed.

The length of time in each mode of operation is also important to the efficiency of the treatment method. The highest filter efficiency or throughput is with a prolonged filtration mode and shorter backwash and draining periods. Throughput is measured as the influent flow volume less the backwash flow volume. Biological treatment has been achieved by adjusting each mode of operation with a wastewater throughput up to 90%. Throughput is impacted by the influent solids loading (flow and Total Suspended Solids (TSS) concentration) by the available head (the weir 201 to the effluent static level) required to accomplish the filtration, and by the backwash flow rate.

As discussed above, the timing of each cycle can have an impact on the efficiency of the filtration process. In order to provide an efficient throughput (70% to 90%) and yet a healthy aerobic environment, the filtration mode should be as long as possible without depriving the bio-film 80 of oxygen needed for synthesis. Generally, the filtration process is completed within approximately two hours, but can extend up to approximately four hours without depriving the biological growth 80 of needed oxygen. Hydraulic loading rates (flow per unit surface area) to achieve biological treatment have been obtained at 5 gallons per minute (“gpm”) per square foot of surface area using a 30 inch bed of media and 5 feet of available head producing a filtration throughput up to 80%. The filtration mode time period is dependent, however, upon the waste content in the fluid that is being filtered. The greater the organic and solid loads present in the influent fluid, the shorter the length of time the filtration mode will last because the particulate build up within the media bed occurs at a faster rate.

The backwash mode should be long enough to clean the excess solids and aerate the remaining bio-growth 80 (generally 20 to 30 minutes at a rate of 5 gpm/square foot of surface area). The backwash period is not as dependent upon the influent solids loading but requires a certain minimum time to scrub the particles from media bundle. The backwashing period can be somewhat shortened by higher flow rates but the volume required to turn over the vessel volume is approximately the same. A longer backwash period at smaller flow rates provides more aeration time and approximately the same backwash volume.

The drain period should be sufficient in length to evacuate the fluid after backwash and further aerate the remaining bio-growth 80 (generally less than 5 minutes). Draining can occur relatively fast, but longer periods in a drained condition may be desirable for additional aeration.

The three modes and periods of operation can be adjusted to maintain a healthy aerobic biological growth while maintaining a high filter throughput. Adjustments are specific to the wastewater characteristics, the fluid flow rate and available head. For example, to maintain an 80% throughput for a high solids concentration, the influent hydraulic loading rate may need to be lowered to maintain longer filtration periods, the backwash flow can be reduced with a longer aeration period, and the period in the drained condition may be extended to fully aerate the biological growth. For weaker wastes, timers to limit the filter run time can be employed to trigger a backwash cycle to maintain the aerobic conditions desired. Dissolved oxygen meters and probes can be employed to measure the effluent and trigger a backwash to maintain minimum dissolved oxygen during filtration. In some instances, air can also be introduced in the influent flow to extend filter run times without the detriment to the health of the biology. Chlorine can be added to the backwash to extend filter run times by control of excess bio-growth. Given the durability of the filament fibers, the media bed 60 does not need to be changed.

FIG. 1C shows another embodiment of the invention configured to introduce air into the fluid to be filtered at the beginning of the filtration process in order to extend the filter mode period of time while maintaining an aerobic environment. FIG. 1C illustrates a closed outer fluid containment structure 115 with a vertical pipe 205 oriented above the weir 201 and backwash channel 202 and perforated plate 30. The vertical pipe 205 includes three openings. One opening 205a conducts the influent across the pipe weir 201 and into the containment structure 15. Another opening 205b allows atmospheric air 204 into the containment structure 115. A third opening 205c conducts the influent fluid and air 204 into the containment structure 115 and onto the backwash channel 202 and perforated plate 30. As influent fluid enters from the influent pipe 20, the closed outer fluid containment structure 115 forces the fluid up towards the vertical pipe 205 through the opening at 205a. The fluid then falls from the vertical pipe 205 out of the opening at 205c, which pulls in atmospheric air through the opening at 205b. The fluid then traps the air in the containment structure 115. The trapped air flows through the media bed 60 and is dispersed in a similar manner as the fluid to be filtered. Air entrainment in this manner extends the aerobic conditions and time allowed in the filtering mode of the cycle. Other methods of aerating or introducing air into the fluid to be filtered may be utilized, but the embodiment described in this paragraph is a method that does not require additional energy input to the bio-filtration process of the present invention.

In other embodiments, shown in FIGS. 1D and 1E, the filter apparatus 10 is configured to allow a portion of the flexible housing 25 to be relaxed during the filtration process. More specifically, an upper portion 25a of the flexible housing 25 is relaxed while a lower portion 25b is still subjected to compression, thereby allowing the media bed 60 in the upper portion 25a to fissure. By allowing greater fissuring at the upper portion 25a, larger openings are created, enabling further penetration of solids into the media bed in the lower portion 25b of the flexible housing during the filtration cycle. A solid structure 33 may separate the upper portion 25a and lower portion 25b of the flexible housing, which assists in the application of different pressures along the respective portions of the flexible housing.

This relaxation can be caused by allowing the pressure within the media bed 60 to equal or become greater than the pressure on the outside of the upper portion 25a of the flexible housing 25. The equalization or increased internal pressure can be accomplished by one or more methods. One method allows the water level on the outside of the upper portion 25a to equal the water level on the inside of the upper portion 25a where the upper zone will naturally begin to fissure. In another method, the lower zone 25b is pressurized by a higher fixed water level and the upper zone is relaxed by isolating and draining away the pressurizing fluid. This method, as shown in FIG. 1D, can use an additional influent pipe 98 that feeds influent from a higher level to engage the lower portion 25b while employing another drain pipe 97 to drain fluid away from the upper portion 25a. In another embodiment, shown in FIG. 1E, one or more siphons 204 can be initiated at a certain level along the flexible housing 25 to cause a back and forth water movement thereby encouraging fissuring in the media bed 60 in the upper zone 25a. In another method, the use of different influent weir levels can cause both the higher and lower zone compressions: 1) the highest weir level establishes the lower zone compression, 2) the upper zone compression is established by the lower weir level, and 3) the relaxation of the upper zone compression is caused when the water level inside the flexible housing 25 approaches a middle weir elevation, which exceeds the pressure on the outside of the flexible housing 25. In another method the lower zone is pressurized by mechanical or pneumatic means and the upper zone is relaxed by one of the methods stated above. In addition, the slower that the equalization occurs, the greater the media bed 60 is optimized to capture solids.

Biological growth 80 may be introduced to a filter through exposure to wastewater. In order to keep the biological growth 80 active, i.e. in a growth phase, the filter apparatus 10 must repeatedly expose the biological growth 80 in the filter media 60 to wastewater fluids and air. In embodiments discussed above, the biological growth 80 is exposed to fluids to be filtered and air via filtering, backwash aeration, and draining on a cyclical basis. For example, the exposure can come from the regular operation of the filter apparatus 10, including the filtering/treatment process followed by the aeration that occurs during the backwash and draining process discussed above. The wastewater provides the nutrients needed to enhance the growth and fixation of the biological growth 80 within the media bed 60.

The periods of each exposure are controlled to maintain an optimized environment for the biological growth 80. A complete cycle to maintain a healthy aerobic biological growth is 2 to 4 hours in filtration, 30 minutes of backwash aeration, and 5 minutes of draining, as discussed above. As previously mentioned, timing of the cycle is also dependent upon the incoming load. Higher solids load can result shorter filter runs. Higher soluble organics can result in faster biological growth, which in turn results in shorter filter runs. Low solids and low soluble organics can result in longer filter runs with the potential of adversely impacting an aerobic environment. In this case timers in the control of the process and/or the use of oxygen monitoring can be utilized to trigger the backwash cycle (before a headloss trigger, i.e. a plugged filter) to maintain the environmental conditions for the bio-filtration process. Dissolved oxygen monitors may also be employed. In a bio-filtration process involving anoxic or anaerobic conditions, similar monitoring may be employed but for the opposite environmental conditions to maintain an anoxic or anaerobic environment. In these cases, lower solids levels will result in longer filter runs.

In another embodiment of the present invention, as shown in FIG. 5C, fluids and air can be introduced to the biological growth 80 simultaneously. In this method wastewater is introduced into the containment structure 15 through a separate conduit 206 and perforated plate (not shown), with the influent pipe 20 and effluent pipe 45 closed and the drain 95 open. Air from the diffuser 90 causes fluidization, rotation, and aeration of the media bed 60 with the introduced wastewater. The air from the diffuser 90 lifts the wastewater supplied by the separate conduit 206 up through the perforated plate 30, through the backwash channel 202, out the flap gate 203, and down through the drain 95. In this embodiment, the bio-filter 10 is operated as a bioreactor without filtration, reducing the soluble constituents through the production of excess biological 80. The media bed 60 is continually cleaned with excess bio-growth 80 and particulates being discharged downstream. In this embodiment the filter apparatus 10 serves as an intermediate treatment step. The filter apparatus 10 can operate this way at a treatment plant or in a remote location in a sewer collection system.

Applications for the embodiment of the filter apparatus 10 shown in FIG. 5C include wet weather treatment where biological treatment of excess wet weather flow is required. During dry weather, the filter apparatus 10 functions as an intermediate treatment step and maintains an active biology 80 within the media bed 60. During excess wet weather water flow, the filter apparatus 10 functions as a complete treatment mechanism suitable for attaining regulatory requirements of biological treatment and satisfying effluent limits imposed on discharges for remote collection systems or at the treatment plant.

Referring again to FIG. 2A or 2B, during initial filling, fluid 22 to be filtered and treated enters from the influent pipe 20 and fills the void 28 between the outer containment structure 15 and flexible housing 25. The air inlet 90 is off. The drain(s) 95 (and 96) is (are) closed.

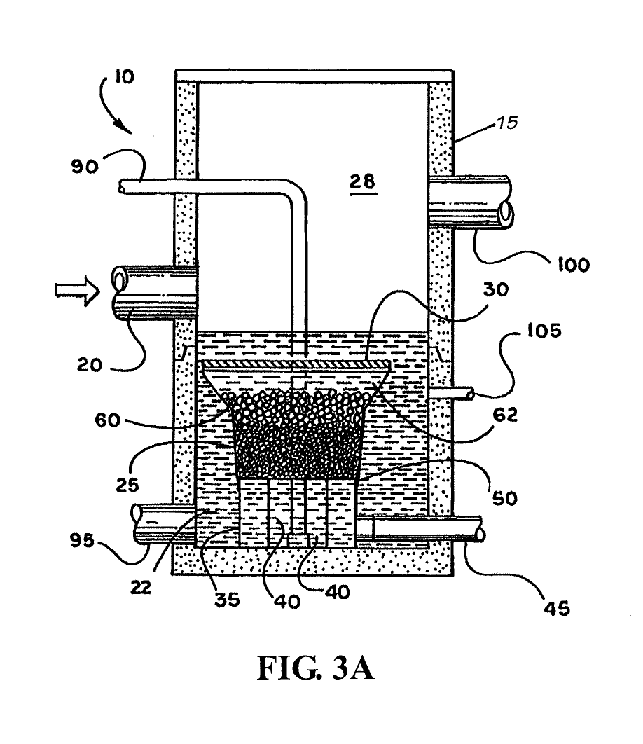

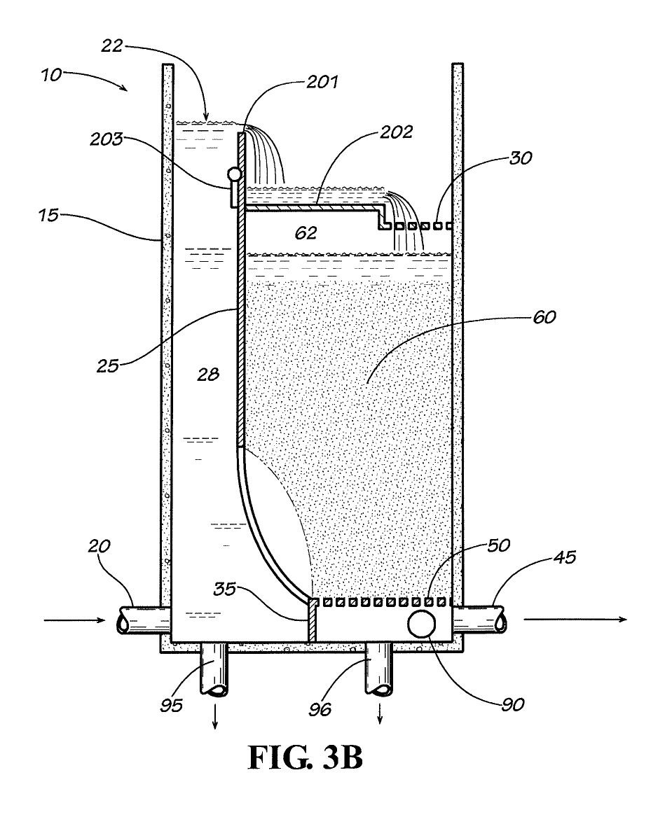

With further reference to FIGS. 3A, 3B and 11, fluid 22 rises above the upper perforated plate 30 of the flexible membrane housing 25, or as in FIG. 3B, the fluid rises above the weir 201, and the fluid 22 enters the top perforated plate 30 for filtering by the filter media 60 and treatment by the biological growth 80. In the case of FIG. 3B, the fluid 22 to be filtered enters over the distribution weir 201, falls down to one or more backwash troughs 202, and enters through the perforated plate 30 for additional aeration during the filtration cycle. The fluid being filtered 22 passes downward through the filter media 60 with particulates being removed from the fluid. In general, larger particulates are removed nearer the top of the filter bed 60 with smaller particulates removed deeper in the media bed 60. As solids begin to bridge the voids between the media fibers 63, matting takes place resulting in removal of both fine and larger particles in the upper media zone (FIG. 11). In addition, the biological growth 80 comes in contact with the soluble organics and micro-constituents as the fluid passes around and through the media bundles 61 of the filter media bed 60. The outer surface of the media bundles 61 filters the larger particulates from the fluid, thus allowing the smaller particulates and more importantly the soluble organics to come into contact with the bio-growth 80 and micro-organisms contained within. The soluble organics are readily taken up by the bacteria of the bio-growth 80 and used as food/energy for cell division (growth).

As the fluid is filtered through the media bed 60, the pore sizes/interstices become smaller, thereby filtering out smaller particulates and further allowing the soluble material to come into contact with the bio-film 80. As described above, when media bundles 61 are coated with particulates and head loss across the coating builds, individual media bundles 61 themselves are compressed creating additional fissures or passageways for additional fluid and solids to go deeper into the media bed 60, until the compressed zone of the media bed 60 no longer allows the fissuring process. The result of the fissuring allows more fluid to be filtered with longer filter runs and in turn allows more of the soluble organic media to come in contact with the bio-film 80 for removal by cell growth.

In other embodiments the filter media housing 25 may include a plurality of components to apply varying compression to different locations in the filter media 60. For example, referring to FIG. 11, the upper portion of the housing 25 may comprise a rigid element connected to a lower membrane (lower portion of housing 25). The upper filter media 60A in such an embodiment is uncompressed from the external fluid because the rigid upper portion will not flex inward. The flexible lower portion of the filter membrane is compressible by the outer fluid to produce a compressed lower bed 60B.

In still other embodiments, the housing 25 may include a lower housing portion with hinged plate walls instead of a flexible membrane. Such walls could be a variety of shapes, including flat wall plates with leak-resistant membranes or materials joining one plate to the next plate. Sliding mechanisms may also be used for a portion of the housing to be compress inward. All such embodiments permit the external fluid pressure to compress the lower portion of the housing and the lower filter media bed 60B inward.

In embodiments where the housing 25 is flexible, the housing 25 may be constructed of single or multi-ply membranes of chlorosulfonated polyethylene (Hypalon), polyvinyl chloride (PVC), rubber, viton, polypropylene, polyethylene, vinyl, neoprene, polyurethane, and woven and non-woven fabrics. In embodiments where rigid materials are used, such as those including an upper rigid portion or including pivotable or sliding housing walls, construction materials include steel, stainless steel, other metals, and reinforced and unreinforced plastics. The filter media housing 25 may be constructed of any suitable material depending on the desired filtering use, types of fluids being filtered, desired corrosive characteristics, and the like.

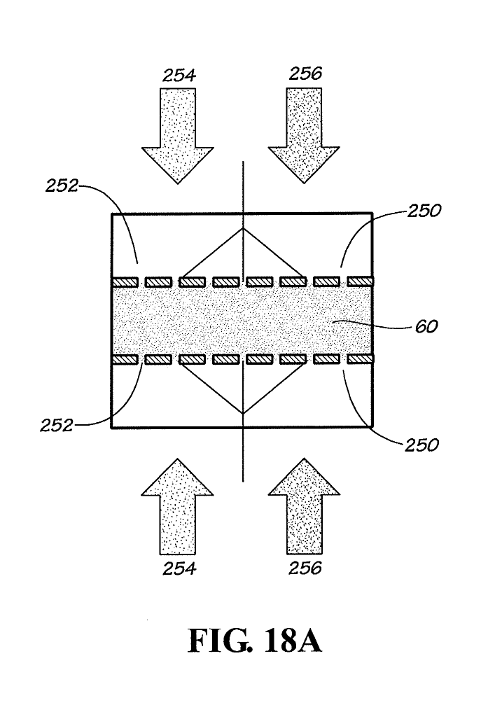

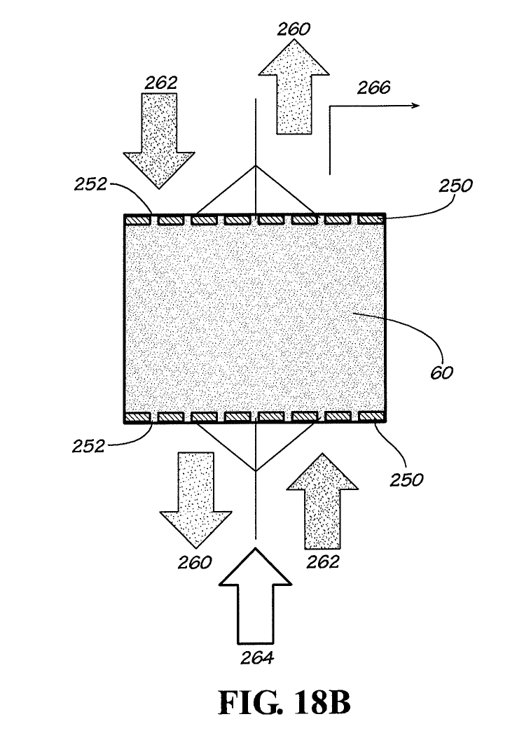

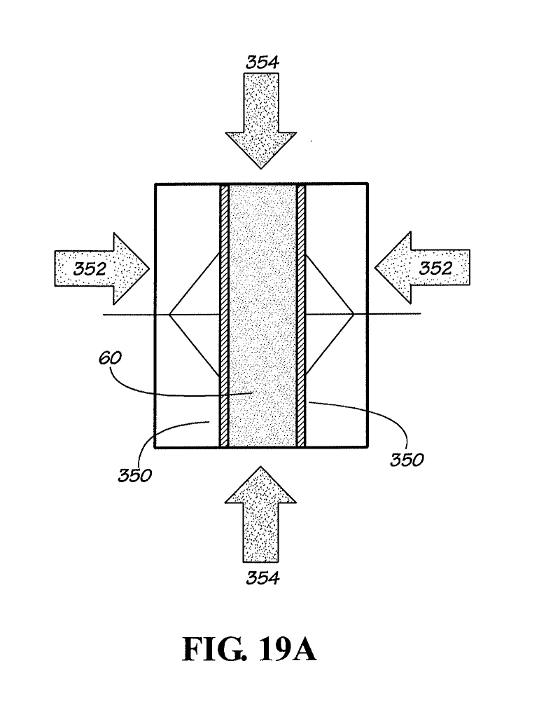

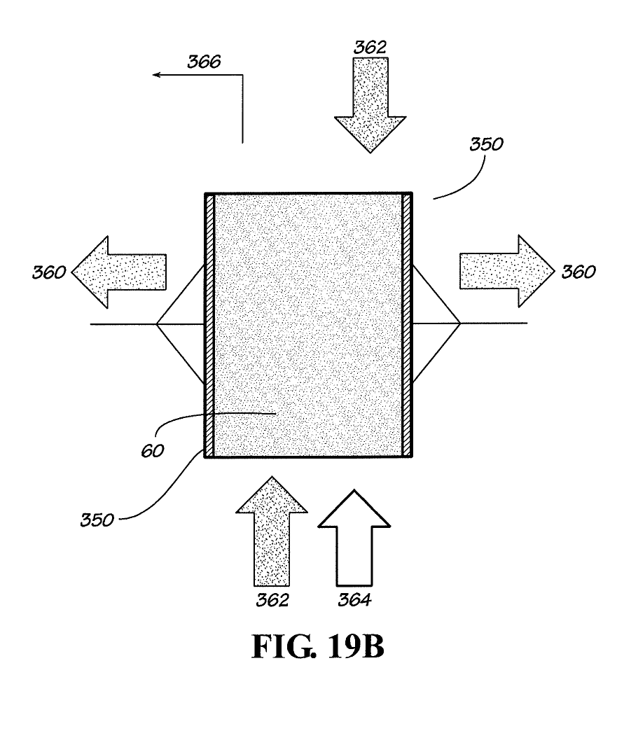

Although the present invention is shown in embodiments with external fluid pressure generating compressive force against the housing 25 and filter media 60, other external forces may also be used to compress the lower filter media bed 60B. For example, in other embodiments, the side walls of the housing 25 may be actuated in an inwardly pivotable or sliding manner through mechanical, electrical, hydraulic, pneumatic, and similar operation. In another example, as shown in FIGS. 18A and 19A, the filter media 60 may be compressed by mechanical plates 250 and 350. As shown in FIG. 18A, the direction of compression 254 can be parallel to the direction of the flow 256 of the fluid to be treated. In such embodiments, the mechanical plates may include perforations 252 for the influent. In other embodiments, as shown in FIG. 19A, the direction of compression 352 can be perpendicular to the flow 354 of the fluid. In such embodiments, the mechanical plates 350 do not need perforations. In this embodiment, the media 60 is contained both above and below the compressed zone of the filter media. Further, in other embodiments, inflatable components may be positioned external to the housing and inflated in a balloon-like manner to press against the housing and compress the filter media.

In another embodiment, a plurality of mechanisms (2 or more) can be used within the same filter housing 25 to create a plurality of compression zones as the fluid to be filtered passes through the media bed. In this embodiment the initial compression zones first encountered by the fluid to be filtered can be decompressed as head loss builds due to the removal of particulates in this zone. The decompression of the first zone(s) allows further fissuring of the media bed and additional solids to penetrate down into the media bed resulting in a greater capacity of the media bed to remove solids.

Referring again to FIG. 11, the top surface of the filter media bed 60 includes space 62 (see also FIGS. 2-4) that is open and untouched by the upper perforated plate 30. In such an embodiment, the upper filter media zone 60A remains uncompressed by not only the housing 25, but also avoids external top down compression from the upper plate 30 because of spacing 62. The initial compression with relatively uncompressed upper filter media bed 60A with an open surface and the compressed lower filter media bed 60B will result in greater particulate penetration than if the upper filter media bed 60A were compressed or the entire bed were compressed. Finer particulates may therefore be captured in the lower media bed 60B as greater penetration is achieved. In another embodiment, the uncompressed space 62 may contain a deeper media bed 60 in which more media containing biological growth 80 for the benefit of greater contact with and removal of soluble organic material as well as particulates.

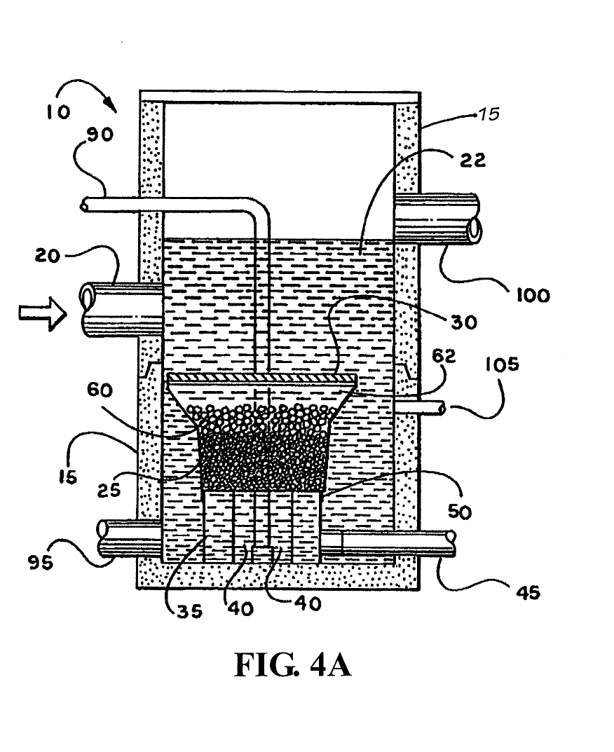

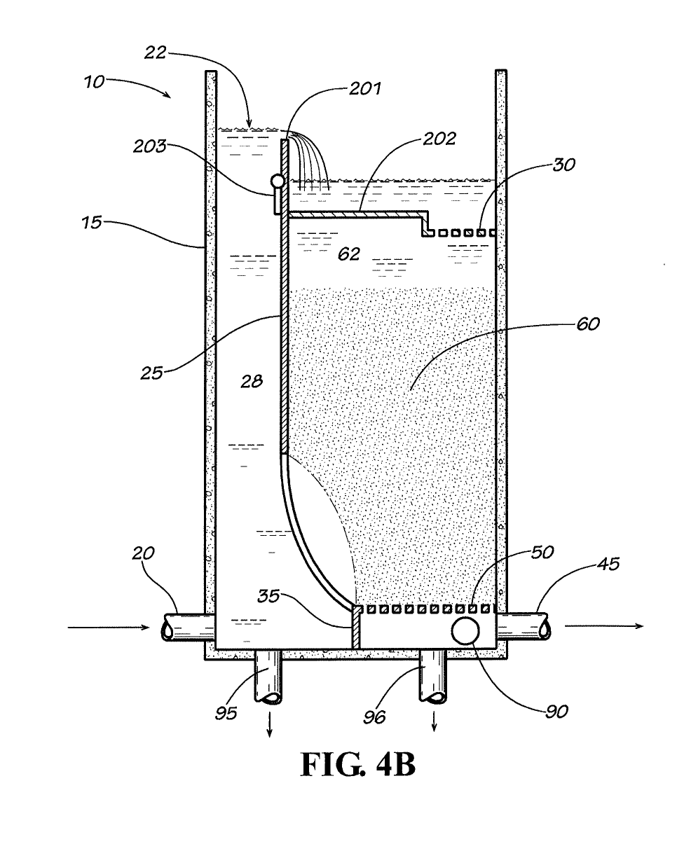

Referring further to FIGS. 3A, 3B, 4A, and 4B, as filtration proceeds and more particulates are removed, the hydraulic head differential across the filter becomes greater (FIG. 3A to 4A and 3B to 4B), causing greater compression in the lower zone 60B by the downward force applied by the increasing headloss, preventing smaller particulates from passing through. The additional compression caused by increasing head loss spreads the biological growth 80 in the lower zones of the media bed 60, thereby creating more contact between the biological growth 80 and soluble organic material that in turn increases the performance of the filter to remove both particulates and soluble organics.

In some embodiments of the invention, the flexible housing 25 shape is also generally wider at the upper portion than at the lower portion of the housing 25. As shown in FIGS. 1A and 1B, in the uncompressed state, the flexible housing 25 protrudes outward and contains a volume of filter media 60. The fluid to be filtered compresses the flexible housing 25 inward. Compression of the flexible housing 25 creates a porosity gradient of highly porous upper layer and with smaller and smaller pores within the filter media 60 as the fluid exits the filter. The highly porous upper zone and less porous middle zone in the filter media 60 is best utilized for particle removal and the lower zone where the biological growth 80 is squeezed becoming more homogenous in the narrow part of the media bed 60 where soluble organics removal is likely. Further, the generally tapered embodiment and shape of the flexible housing 25 provides additional filter benefits as the media 60 is more loosely packed near the more “open” upper portion and is more densely packed nearer the bottom portion of the housing.

Comparing FIGS. 3A and 3B to 4A and 4B shows that the level of the fluid 22 within the containment structure 15 increases due to the build-up of particles on the filter media 60 and the growth of the bio-film 80 within the media 60. Referring to FIGS. 4A and 4B, an embodiment of the invention is shown when the filtration cycle has reached its latter stages and/or during a period of peak upstream fluid flow. The latter stage of the filtration cycle is reached when the filter media 60 captures its maximum particle load, and the depth of fluid 22 reaches its maximum fluid level. Once this level is reached, the influent 20 is stopped, and the backwashing cycle (FIG. 5) is initiated.

FIGS. 5A and 5B show the filter media 60 being backwashed to remove captured materials, including particulate build up and excess biological solids. The excess biological solids include any excess biological growth 80. After backwash, excess biological solids in the outer zone of the media bundle 61 are scrubbed in the process leaving cleaned fibers 63 that, when placed back into the filtration cycle, form the passageways in the upper less compressed portion of the media bed 60. Scrubbing the media 60 with an air/water fluidized backwash does not fully clean away all of the biological growth 80 contained within the interstices of the media bundles 61. At times the biological growth is so great that a low dose of chlorine is needed during backwash in order to clean the media 60 to the point at which the initial head loss is minimized when the next filter cycle begins.

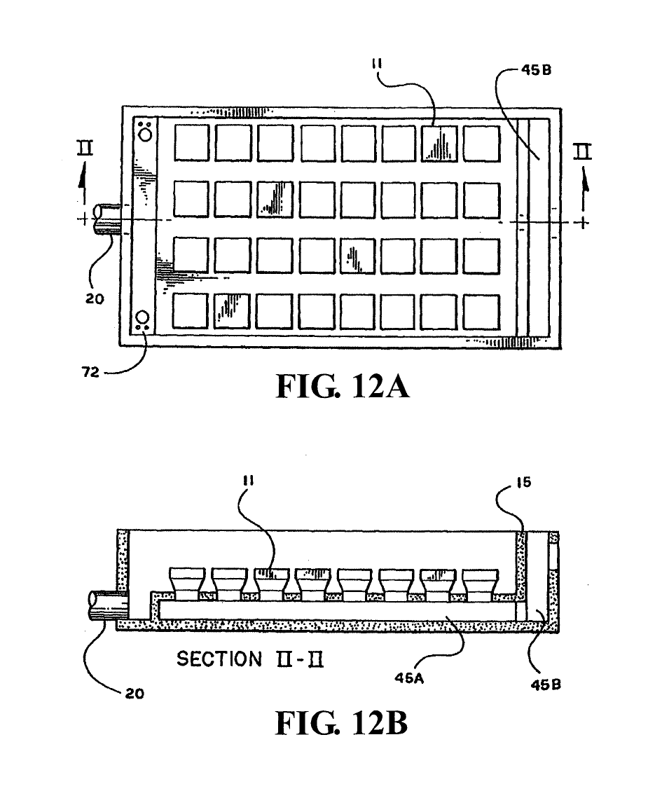

During a backwash operation, fluid entry from the influent pipe 20 is stopped, as shown in FIGS. 5A and 5B. Make-up water 23 is introduced into the filter effluent pipe 45 or to an open-close connection valve to the outer section of the housing base portion 35. A backwash outlet, such as a backwash pump discharge 105 connected to a backwash pump 72 (FIG. 12A), can be used to remove the backwashed particles and excess biological solids from the containment structure 15 or the backwashed fluid can be removed from the containment structure 15 by opening a drainpipe 95. During backwash the fluid level within the containment structure 15 is lower than the water level within the filter media housing 25 causing the housing 25 to expand.

In the backwash cycle, an air inlet 90 supplies air from a blower at the base portion 35 or under the lower perforated plate 50. The backwashed fluid containing the concentrated particulates/excess biological growth 80 is typically subjected to further treatment.

The air from the air inlet 90 enters the center section or to one side of the base 35 and rises through the center or to one side of the lower perforated plate 50 and up through the center or to one side of the filter media 60. The upward airflow causes the filter media 60 to circulate within the expanded flexible filter media housing 25 during the backwashing cycle. Circulation of the filter media 60 causes the media bundles 61 to collide with the upper perforated plate 35 and with other media bundles 61 helping particulates, organic solids, and excess biological growth 80 to dislodge from the media bundles 61. In addition, the air provides an important step of the treatment process by oxygenating the biological growth 80.

The air circulates scrubs, aerates, and lifts the spent backwash fluid through the upper perforated plate 30 and into a backwash trough 202 contiguous to the air elevated fluid. The upper perforated plate 30 retains the media within the filter housing 25. The backwash fluid exits the outer containment structure 15 by either gravity drainage through drain 95 or pumping through outlet 105. In one embodiment shown in FIG. 5B, the upper perforated plate 30, backwash trough 202, and the flap valve 203 are located below the maximum fluid level 22, which is set by the weir 201. In this manner, the air pressure and energy consumed is minimized.

After backwashing and aeration of the biological growth within the media, the drain 96, as shown in FIGS. 1B-5B, is opened to remove fluid from inside the filter housing 25. As this draining occurs, the remaining fluid is completely drained from the media bed 60, creating a vacuum effect that pulls in air into the cleaned media bed 60, further aerating the bio-film 80 within the media bed 60. A plurality of drains 95 and 96 may also be provided.

As shown in FIG. 5D, an embodiment of the present invention may be used to denitrify by converting nitrates/nitrites to nitrogen gas. The denitrifying filter 10 may utilize the same general components during the filtration process as discussed in embodiments shown in FIGS. 1B-4B, discussed above. However, the denitrifying filters 10 operate in an anoxic or anaerobic environment, using bio-growth 80 that uses nitrates and nitrites to grow. In fact, such bio-growth 80 can be harmed from exposure to oxygen. Therefore, the backwash cycle is performed by injecting only water into the media bed 60 during the backwash process. The water may be supplied by water injecting structure 99, including, but not limited to a water jet, a water pump, or diffuser nozzles. After backwashing, the filter 10 is partially drained, sufficiently to lower the media bed 60 without pulling air in and prior to compression by the incoming fluid. For example, drainage is stopped before the top of the media bed 60 becomes exposed to air.

Because of the significant surface area within the fiber media bundles 61 for denitrifying biology to grow, the depth of the media bed 60 need not be as great as conventional denitrifying filters. Further, since the denitrifying process typically occurs at or near the end of a wastewater treatment system, the solid particulate concentration of the fluid to be treated is much lower than that of the particulate concentration of raw waste water. Therefore, the bio-filter 10 has a high loading capacity and can operate for longer periods of time than conventional denitrifying filters. To further enhance the denitrification process, a carbon source such as methanol or upstream wastewater carbon source may be added to the filter influent.

FIGS. 18B and 19B illustrate the backwash process as implemented by embodiments of the present invention that employ mechanical plates. As shown in FIG. 18B, the mechanical plates 250 are activated to expand the filter media 60. The direction of expansion 260, is opposite from the direction of compression shown in FIG. 18A. The backwash make-up fluid 262 is then introduced into the media 60 to interact with the trapped particulate and excess biological growth in a similar fashion as the influent as described in FIG. 18A, with the backwash make-up fluid 262 entering through the perforations 252 of both plates 250. The aeration process is then initiated, with the air 264 lifting the spent backwash 266 out of the filter media 60. As shown, air 264 is introduced at only one plate 250 in order to have the spent backwash 266 exit through the perforations 252 of the opposite plate 250.

In the embodiment of the present invention as shown in FIG. 19B, the mechanical plates 350 are activated in the expansion direction 360, causing the filter media 60 to expand. The backwash make-up fluid 362 is introduced to the fiber media 60. The backwash make-up fluid 362 may be introduced from one or two sides. Air 364 from the aeration process is introduced to the filter media 60 and removes the spent backwash 366 from the filter media 60. Like the process shown in FIG. 18B, the air 364 is introduced opposite the side from which the spent backwash 366 exits the media bundle 60.

In certain outer containment structures 15 such as earthen basins with permanent lower water levels or natural water features (such as lakes), the outer containment structure 15 will not be drained, and the backwash water will be discharged outside of the outer containment structure 15. In this application the compressible media housing 25 may be actuated inwards or outwards by an inflatable balloon or similar alternative method as described previously. In an application where the outer containment structure 15 is a natural water feature with a fixed water level, the fluid inlet to the filter may be closed when backwashing occurs.

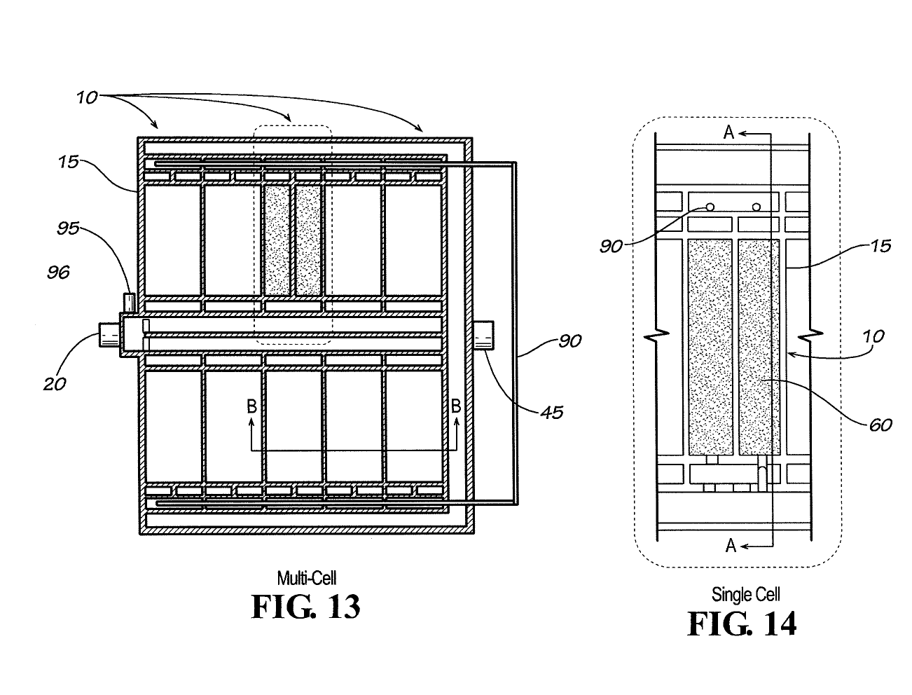

As shown in FIGS. 13-16, multiple filtration units 10 may be used in connection with one another. The filtration units 10 may share portions of outer containment structures 15, influent piping 20, effluent piping 45, air inlet piping/diffusers 90, and drainage pipes 95, 96. The filtration units 10 may employ their own upper and lower perforated plates 30 and 50, bases 35, flexible housing 25, media beds 60, weirs 201, and backwash troughs 202 to perform the bio-filtration and other processes as discussed above.

Referring to FIGS. 12A and 12B, the containment structure 15 may include a plurality of filter units 11 wherein the base may be a wall of an effluent channel/conveyance 45A or a piping network underlying one or more filter units 11. In such embodiments, the channel wall or piping serves as the base to support one or more filter units 11 in an upright position within the outer containment structure 15. The integrated filter unit 11 in the conveyance 45A may not have baffles 40. In embodiments utilizing a plurality of filter units 11, the containment structure 15 may include a large basin, natural feature, manmade containments, and the like, where a large quantity of fluid is to be filtered. The filter units 11 include compressible media 60 and a filter media housing 25 and operate as previously described with reference to a single filter unit.

In a large containment environment as shown in FIGS. 12A and 12B, the underlying effluent conveyances (or piping) 45A may all connect to a larger effluent conveyance 45B for carrying off filtered fluid. In other embodiments underlying conveyances 45A may be directed to other desired locations and conveyance points. FIGS. 12A and 12B also show that one or more backwash pumps 72 may be installed for removing backwash fluid from the containment structure 15 following the backwash process.

The combination of biological treatment and filtration as described above, with the ability of the filter to handle high solids loading, can be used for many different treatment applications at much lower capital and operating costs and with a much smaller footprint than conventional processes. For example, raw sewage can be biologically treated and filtered at the same time without the need for both upstream and downstream clarification. This treatment process may qualify as secondary treatment, either in combination with other steps or a stand alone process. In addition, the filter apparatus 10 can be used in a pretreatment step, an effluent polishing process, an enhanced primary process, a roughing filter, parallel biological treatment process, and/or as a wet weather treatment process.

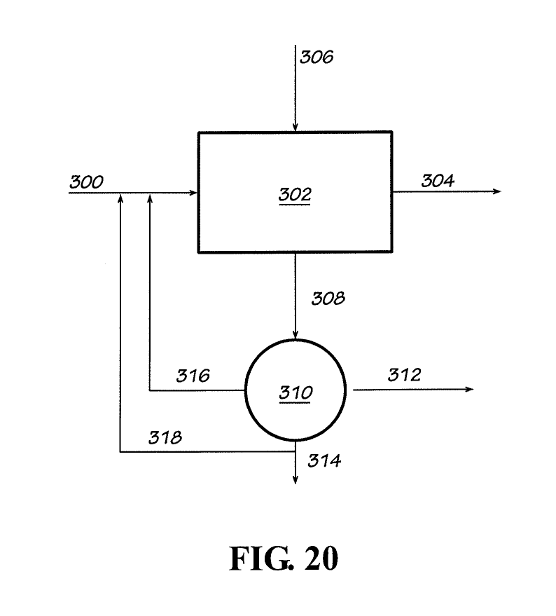

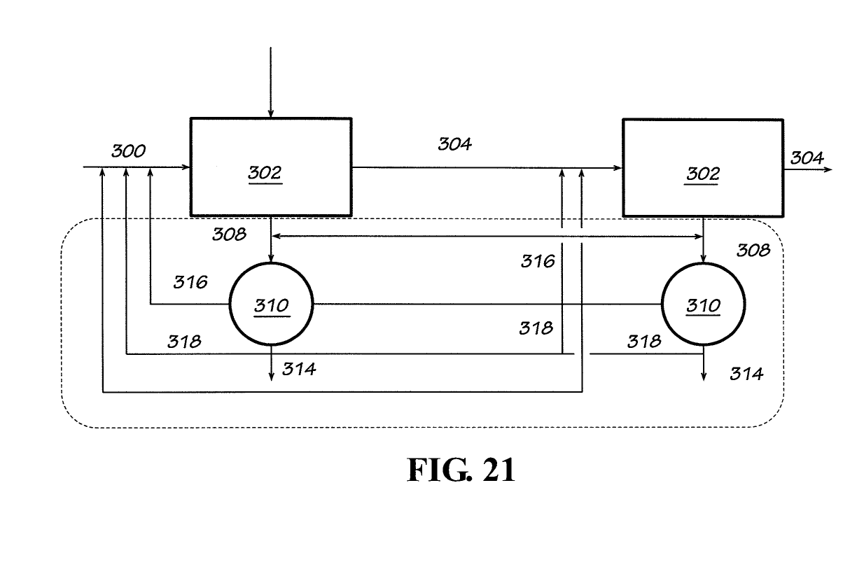

For example, the filter apparatus may be used in a bio-filtration process that incorporates recycling the backwash after it has been subject to a clarifier/thickener process. As shown in FIG. 20, influent wastewater 300 enters the biological treatment filter apparatus 302, which filters and treats the wastewater as discussed above. The effluent 304, after being biologically treated and filtered, exits the biological treatment filter apparatus 302. The backwash makeup fluid and air 306 enters the biological treatment filter apparatus 302 to remove the backwash 308, which includes fluid, captured particles, and excess biological growth. The backwash 308 can then be sent to a solid clarifier/thickener 310 to produce supernatant 312 and thickened solids 314. The supernatant 312 and solids 314 can go to other processes and apparatuses, or the supernatant 316 and the solids 318 can be run through the biological treatment filter apparatus 302 again. This process can be carried through in a single stage process, as shown in FIG. 20, or in a multi-stage biological recycling process that may or may not recycle the backwash, as shown in FIG. 21. A plurality of bio-filtration processes can be employed in order to separate different forms of biological treatment for carbon oxidation, nitrification, de-nitrification, phosphorous removal, and anaerobic treatment.

The present invention may also be used to treat intermittent wastewater discharges at a treatment plant or sewer overflows in a collection network. Such intermittent wastewater discharges may be caused by wet weather conditions in collection networks that carry both stormwater runoff and sewage (combined sewer overflows—CSOs) and by rainfall induced leakage into the sewer pipes (sanitary sewer overflows—SSOs). As discussed above in reference to FIG. 5B, the combined biological filter 10 may be used as a roughing filter preceding other biological treatment processes at a treatment plant during dry weather. The roughing bio-filter would lessen the load on the downstream biological processes and would save energy consumed by the downstream biological process because the roughing filter reduces the amount of aeration required for soluble and particulate carbonaceous biological oxygen demand (CBOD). When wet weather causes excess flow that the normal plant cannot handle, the bio-filter 10 can provide biological treatment and filtration for this excess flow with the discharge directly to disinfection rather than to downstream biological treatment. The bio-filter effluent 45 can be sufficient treatment for the typically more dilute wet weather flows. This offers a cost savings both with respect to energy consumption during dry weather and capital investment for expanding a treatment plant for conventional biological treatment of the higher wet weather flows. In a remote collection system location where excess wet weather spills tend to occur, the bio-filter 10 may be used to biologically treat and filter before disinfecting the overflow. During dry weather, the filter should be fed with sufficient amount of sewage to keep the micro-organisms healthy. In this mode of operation the bio-filter 10 will be periodically aerated while being fed a small portion of the sewage flow with all the flow from the filter going back into the downstream sewer system. Similar to the application at the treatment plant, the remote bio-filter serves as a roughing filter in the collection system and results in organic load reduction to the downstream wastewater treatment plant reducing the overall load and energy consumption. When a wet weather event occurs, causing flows that exceed the carrying capacity of the downstream pipes, the excess flow is biologically treated and filtered before disinfection and discharged. Again this scenario can have capital and operating cost advantages over the alternative pipeline infrastructure expansion for transport and downstream treatment at the wastewater plant. The simultaneous wastewater feed and aeration does not have to be continuous, but must be in sufficient doses and length to maintain healthy biological growth 80 within the fiber media 60.

The present invention can be utilized in series to provide aerobic carbon oxidation, separate stage nitrification, separate stage denitrification, and separate stage anaerobic/anoxic treatment for phosphorous uptake, similar to stages of activated sludge processes and other submerged attached growth bioreactors.

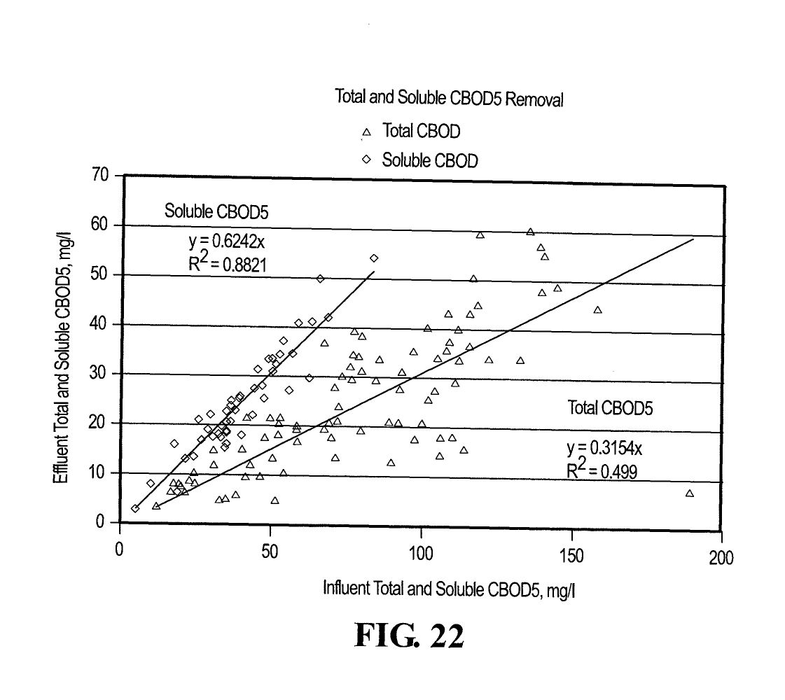

The combined biological treatment and filtration of particulates of the present invention is represented by the bio-filter test data shown in FIG. 22. The data shows the removal of both soluble and total 5-day carbonaceous biological oxygen demand (CBOD₅). Soluble CBOD5 is a sub-component of the total CBOD5 and consists of micron and submicron size organic matter that is quickly utilized by bacteria in the growth of additional bio-growth 80. Particulate CBOD5 consists of larger particles. This data shows that the filter of the present invention reduces soluble CBOD5 as well as particulate CBOD5. When the filter was drained and left drained for a period of time such as a 5-day window, the soluble CBOD5 removal would go to zero, leaving the biological growth 80 dormant or at a diminished population level. When the filter was put back into operation, the soluble CBOD5 reduction required 2 to 3 days to return to the average removal shown in FIG. 22. An increase in the depth of the media bed 60 increased the amount and exposure of the bio-film 80 within the fiber media bundles 60 to the incoming wastewater.

Accordingly, while the invention has been described with reference to the structures and processes disclosed, it is not confined to the details set forth, but is intended to cover such modifications or changes as may fall within the scope of the following claims.

What is claimed is:

1. A fluid filtering system configured to filter and to biochemically treat a fluid, comprising:
a. a containment structure;
b. a filter media comprised of compressible media bundles configured to segregate and separate particulate material from the fluid passing through the filter media contained by the containment structure;
c. a biological growth, wherein the biological growth is hosted by the media bundles of the filter media and is configured to biochemically treat the fluid;
d. an influent inlet;
e. an effluent outlet;
f. a backwash component; and
g at least one drain.

2. The fluid filtering system of claim 1, wherein the media bundles of the filter media are detached.

3. The fluid filtering system of claim 2, wherein the media bundles further comprise fiber filaments.

4. The fluid filtering system of claim 3, wherein the fiber filaments have a denier of approximately 11μ to 13μ (micron) in diameter.

5. The fluid filtering system of claim 4, wherein the media bundles comprise approximately 15,000 filament fibers per bundle.

6. The fluid filtering system of claim 3, wherein the fiber filaments are woven.

7. The fluid filtering system of claim 3, wherein the fiber filaments are secured by a clip.

8. The fluid filtering system of claim 1, further comprising a filter media housing, wherein the filter media housing is positioned within the containment structure and is configured to contain the filter media.

9. The fluid filtering system of claim 8, wherein the filter media housing is configured to compress the filter media during filtering of the fluid.

10. The fluid filtering system of claim 9, wherein the filter media housing is compressible.

11. The fluid filtering system of claim 10, wherein the filter media housing further comprises an upper zone and a lower zone, wherein the lower zone is configured to be compressed during the filtering of the fluid and the upper zone is configured to be relaxed during the filtering of the fluid, allowing fissuring to occur within the filter media in the upper zone.

12. The fluid filtering system of claim 11, further comprising a siphon, wherein the siphon is configured to circulate the fluid to encourage the fissuring within the filter media in the upper zone.

13. The fluid filtering system of claim 11, further comprising an additional influent pipe associated with the lower zone and a drainage pipe associated with the upper zone, wherein the additional influent pipe provides fluid to apply pressure to the lower zone to compress the filter media and the drainage pipe is configured to direct fluid away from the upper zone to encourage the upper zone to relax during filtering of the fluid.

14. The fluid filtering system of claim 8, wherein the filter media housing is compressed by mechanical plates.

15. The fluid filtering system of claim 14, wherein the mechanical plates apply compression in a direction that is perpendicular to the flow of the fluid through the filter media.

16. The fluid filtering system of claim 14, wherein the mechanical plates apply compression in a direction that is parallel to the flow of the fluid through the filter media.

17. The fluid filtering system of claim 16, wherein the mechanical plates are configured to allow the fluid to pass through.

18. The fluid filtering system of claim 1, wherein the containment structure is a closed containment structure and further comprises a vertical pipe, the vertical pipe comprising a first opening configured to receive the fluid from the influent inlet, a second opening configured to receive atmospheric air, and a third opening configured to pass a mixture of the fluid and the atmospheric air to the filter media, wherein the configuration of the vertical pipe and the first, the second, and the third openings are configured to act as a vacuum to pull in the atmospheric air through the second opening when the fluid is passed through the vertical pipe.

19. The fluid filtering system of claim 1, wherein the backwash component comprises a diffuser that is configured to push air into the filter media to remove the captured particulate and excess biological growth from the filter media.

20. The fluid filtering system of claim 19, wherein the backwash component comprises a water injecting structure.

21. A method of filtering and biologically treating a fluid, comprising:
a. introducing the fluid to a compressible containment structure containing filter media comprised of compressible detached synthetic fibrous media bundles;
b. filtering the fluid through the compressible containment structure, comprising;
i. compressing the compressible containment structure, wherein the compression compresses the filter media;
ii. introducing the fluid to the media bundles, wherein the media bundles host a biological growth;
iii. cleaning the fluid comprising:
A. contacting the fluid with the biological growth to have the biological growth interact with organic constituents contained in the fluid; and
B. filtering particulates out of the fluid through the filter media; and
iv. removing the cleaned fluid from the compressible containment structure;
c. backwashing the compressible containment structure, comprising:
i. applying backwash make-up; and
ii. aerating, wherein the combination of the backwash make-up and the aeration removes spent particulates and excess biological growth within the filter media and decompresses the media bundles within the filter media; and
d. draining the filter media.

22. The method of claim 21, wherein the method is performed at a throughput rate ranging between 70% to 90%.

23. The method of claim 22, wherein the method is performed to maintain the biological growth in a growth phase by applying a hydraulic loading rate of 5 gallons per minute (“gpm”) per square foot of surface area.

24. The method of claim 23, wherein filtering the fluid is done for approximately two to four hours, backwashing the compressible containment structure is done for approximately twenty to thirty minutes, and draining the filter media is done for approximately five minutes.
